(19) United States
(12) Patent Application Publication
(10) Pub. No.: US 2017/0355452 A1
(43) Pub. Date: Dec. 14, 2017

(54) AIRCRAFT LANDING GEAR, AIRCRAFT CARRYING SUCH AND METHODS

(71) Applicant: Paul Vickers, Hamilton (NZ)

(72) Inventor: Paul Vickers, Hamilton (NZ)

(21) Appl. No.: 15/542,399

(22) PCT Filed: Jan. 8, 2016
(86) PCT No.: PCT/IB2016/050076

§ 371 Date: Jul. 7, 2017

(30) Foreign Application Priority Data
Jan. 8, 2015 (NZ) 703670

(51) Int. Cl. B64C 25/06; B64C 25/50; B64C 35/00; B64C 25/34

(52) U.S. Cl. CPC B64C 25/06; B64C 25/34; B64C 25/50; B64C 35/008

(57) ABSTRACT

An aircraft comprising a fuselage and an undercarriage dependent from the fuselage, the undercarriage including at least one caster assembly mounting a landing wheel to provide vertical support for the aircraft when on land and able to caster relative the fuselage.

### FIELD OF THE INVENTION

The present invention broadly relates to aircraft landing gear and aircraft carrying such landing gear and methods associated with the same.

### BACKGROUND

The world's population is increasing. As such more people are around and therefore there is more people travelling. Some prefer to travel between places efficiently. Some prefer to travel to remote places. One form of transportation used more and more is flying, whether long haul in large aircraft with a carrying capacity of 100 people or by way of medium to small sized aircraft for short distances and/or where as few as 1 or 2 people are carried. As such there is an increasing demand on airports to increase their capacity to allow more aircraft to land, more pressure to increase airspace, flight paths and/or to build more airports in places that would otherwise not have accommodated airports. Therefore there are more aircraft in the airspace than ever before and this is set to continue. At times the weather can be inclement. Despite this, there is a need to ensure flight schedules are maintained and an increasing demand has been placed on pilots to land in such inclement weather, including strong cross winds, where otherwise landings would not be allowed or would not be possible. Landing in cross wind situations can be difficult, even for skilled pilots. With more recreational pilots joining the air, landing in small airports that may sometimes be unmanned, or remote places that may only be accessed by water is prevalent. These recreational pilots may need to land in inclement weather where strong cross winds prevail and then to take off on water or land yet many aircraft may be restricted to land in such conditions or require a great deal of skill to land safely.

Therefore there is a need to provide aircraft landing gear of or for an aircraft that is able to address the problems identified above.

### BRIEF DESCRIPTION OF THE INVENTION

Accordingly in a first aspect the present invention may be said to broadly be an aircraft comprising
a. a fuselage
b. an undercarriage dependent from the fuselage, the undercarriage including at least one caster assembly mounting a landing wheel to provide vertical support for the aircraft when on land and able to caster relative the fuselage.

Preferably the caster assembly comprises a caster axle mounted for rotation on a caster axis that is parallel a vertical plane passing through the aircraft's longitudinal axis.

Preferably the caster axis is parallel the aircraft's vertical axis.

Preferably the undercarriage is the primary aircraft weight bearer.

Preferably the landing wheel is the primary aircraft weight bearer.

Preferably the landing wheel is positioned forward of the centre of gravity of the aircraft.

Preferably the fuselage is an elongate fuselage extending along the aircraft's longitudinal axis, the caster assembly comprises a caster axle mounted for rotation on a caster axis that is parallel a vertical plane that passes through the longitudinal axis.

Preferably the caster axis lies in the vertical plane.

Preferably at least two caster assemblies are provided, each mounting a respective landing wheel.

Preferably at least two caster assemblies are provided each mounting a respective landing wheel to provide a landing wheel more proximate the nose of the aircraft and a landing wheel more proximate the tail of the aircraft.

Preferably a first landing wheel is positioned forward of the centre of gravity of the aircraft and a second landing wheel is positioned aft of the centre of gravity of the aircraft.

Preferably each caster axis of each caster axle are parallel each other.

Preferably the caster axis of each caster axle are not all parallel each other.

Preferably the aircraft comprises one said caster assembly mounting a landing wheel more proximate the nose of the aircraft and one landing wheel more proximate the tail of the aircraft.

Preferably the one landing wheel more proximate the tail of the aircraft does not caster and has its rotational axis parallel the aircraft's lateral axis.

Preferably the landing wheel is mounted for rotation by said caster assembly about a wheel axis.

Preferably the wheel axis is able to rotate at least partially around the caster axis, when the landing wheel casters about the caster axis.

Preferably when the wheel axis is perpendicular the aircraft's longitudinal axis when seen in plan view, the aircraft when moving forward on land, will travel in a direction (track) coincident the aircraft's longitudinal axis.

Preferably when the wheel axis is not perpendicular the aircraft's longitudinal axis when seen in plan view, the aircraft when moving forward on land, will travel in a direction (track) at an angle to the aircraft's longitudinal axis.

Preferably the wheel axis lies in a plane that is parallel a plane in which the aircraft's longitudinal and lateral axes lie.

Preferably at least one arm extends between the caster axle and the landing wheel to mount said wheel in manner able to be able to caster.

Preferably the at least one arm carries a wheel axle coaxial the wheel axis and about which the wheel can rotate.

Preferably the caster assembly can, in a first condition, allow the landing wheel to freely caster and in a second condition, cause the wheel to be coupled to pilot controlled steering input that can control the operative rolling direction of the landing wheel when the aircraft is travelling on land.

Preferably the caster assembly can, in a first condition, allow the landing wheel to freely caster and in a second condition, causes the caster axle to be coupled to pilot controlled steering input that can control the operative rolling direction of the landing wheel when the aircraft is travelling on land.

Preferably when coupled to pilot controlled steering input the wheel axis can be caused to move about the caster axis by said steering input.

Preferably the wheel axis can move about the caster axis within a limited range of movement.

Preferably the caster assembly in a first condition allows the landing wheel to freely caster and in a second condition is coupled to a steering mechanism of said undercarriage.

Preferably the steering mechanism is operatively connected to pilot operable steering input (eg foot pedals) that (a) when the caster assembly is in its first condition, is decoupled from the caster axle and (b) when moving from the first condition to the second condition of the caster assembly, by an upward movement of the caster axle relative the fuselage displace, can cause the steering mechanism to couple with the caster axle.

Preferably the steering mechanism includes a steering block engaged to a steering arm that is operatively connected to pilot operable steering input (eg foot pedals), the steering block and caster axle mounted for relative movement to each other to (a) allow relative rotation about the caster axis when the caster assembly is in its first condition and (b) allow relative displacement in the caster axis direction when the caster assembly moves between its first and second conditions.

Preferably the steering block is mounted about the caster axle.

Preferably the steering block has a hole thought it, in which the caster axle is located.

Preferably the steering block and the caster axle are able to couple together when the caster assembly is in the second condition to rotationally move together, by virtue of engagement of complimentary key and recess features of the caster axle and steering block.

Preferably the key feature is a pin extending radially said caster axis and said recess is provided in a surface of said steering block.

Preferably the caster assembly is biased to said first condition and only upon contact with land by said landing wheel, is the caster assembly moved towards the second condition.

Preferably such contact with land results in the wheel bearing aircraft weight of a sufficient amount to overcome the bias.

Preferably the caster assembly can, when in a first condition, allow the landing wheel to freely caster but under the influence of a rotational bias that, when the aircraft is travelling forward on land, encourages the wheel to move to an operative rolling direction that causes the aircraft's longitudinal axis to be coincident its direction of travel (track).

Preferably when in the second condition, the landing wheel is no longer under the influence of said rotational bias.

Preferably the aircraft longitudinal axis is coincident the aircraft heading.

Preferably the aircraft's rudder and steering mechanism are coupled so that when the aircraft is landing in a crabbed condition and the rudder is position to maintain the aircraft on track, the steering mechanism cannot couple to the caster axle when the landing wheel's rotational axis is perpendicular to the track of the aircraft.

Preferably the caster axle of a first caster assembly is coupled to a caster axle of a second caster assembly in a manner to transfer torque between caster assemblies about respective caster axes.

Preferably a torque transfer mechanism is provided between adjacent caster assemblies.

Preferably each caster assembly has a torque arm extending radially from said caster axle, the torque arm of one caster assembly coupled to the torque arm of another caster assembly.

Preferably the aircraft is an amphibious aircraft as herein described.

Preferably the landing wheel(s) is/are the primary load bearing wheel(s) of the aircraft when on land.

Accordingly in a second aspect the present invention may be said to broadly be an aircraft with an undercarriage of a plurality of aircraft centreline mounted landing wheels able to be controlled for steering the aircraft by the aircraft's pilot when travelling on land, in manner what causes each landing wheel to be turned differentially.

Preferably the wheels are mounted to be able to be so controlled in one mode and in a second mode are able to passively caster relative the aircraft centreline.

Accordingly in a third aspect the present invention may be said to broadly be an aircraft with an undercarriage of a plurality of centreline mounted landing wheels able to be controlled for steering the aircraft when travelling on land in manner what causes each wheel to be turned so that each wheel's rotational axis converges at centroid when seen in plan view.

Preferably the wheels are mounted to be able to be so controlled in one mode and in a second mode are able to free caster relative the aircraft centreline.

Accordingly in a fourth aspect the present invention may be said to broadly be an aircraft comprising
a. a fuselage
b. an undercarriage dependent from the fuselage, the undercarriage including at least one caster assembly mounting a landing roller to provide vertical support for the aircraft when on land and able to caster relative the fuselage.

Preferably the landing roller is selected from one of a wheel and a track assembly that comprises a roller wheels mounted track.

In a further aspect the present invention may be said to broadly be an amphibious aircraft comprising a primary fuselage presenting a hull form extending along the aircraft centreline to support the amphibious aircraft on water, and at least one landing wheel mounted at and partially yet sufficiently exposed from a recess in the hull form to be able to support the amphibious aircraft, including for landing and take-off, on land.

In a further aspect the present invention may be said to be an amphibious aircraft comprising a primary fuselage presenting a hull form along the amphibious aircraft centreline to support the aircraft on water, and at least one landing wheel mounted at the hull form and always presented to be able to support the aircraft, including for landing and take-off, on land.

Preferably the landing wheel is mounted in a recess of the hull form and partially yet sufficiently exposed from a recess in the hull form to be able to support the amphibious aircraft.

Preferably the at least one landing wheel has its rotational axis positioned inside the recess and less than half the wheel is exposed from the recess outside the hull form.

Preferably less than one third of the at least one landing wheel is exposed from the recess outside the hull form.

Preferably said at least one landing wheel is positioned at the centreline of the amphibious aircraft.

Preferably the at least one landing wheel is always presented in a manner capable of landing and support of the amphibious aircraft on land.

Preferably said amphibious aircraft comprising an undercarriage that includes said at least one landing wheel.

Preferably the undercarriage allows the wheel to translate between an up and down position, both said up and down positions presenting said at least one landing wheel in a manner capable of landing and support of the amphibious aircraft on land.

Preferably the undercarriage is secured to the hull form in the recess.

Preferably the undercarriage is located in the recess save for at least part of the at least one landing wheel being exposed from the recess outside the hull form.

Preferably said undercarriage includes a caster assembly mounting said at least one landing wheel in a manner able to caster.

Preferably the caster assembly mounts said at least one landing wheel so that it can caster to allow the amphibious aircraft to land on land in crabbed condition and travel over and in contact with land in such crabbed condition.

Preferably the caster assembly can, in a first condition, allow the at least one landing wheel to freely caster and in a second condition, causes the caster axle to be coupled to pilot controlled steering input that can control the operative rolling direction of the landing wheel when the aircraft is travelling on land.

Preferably said first condition corresponds to said wheel being in said down position and said second condition corresponds to said wheel being in said up position.

Preferably when in the up position, the wheel is coupled to pilot controllable steering input.

Preferably when in the down position, the wheel is able to freely caster yet be biased towards one rotational caster position.

Preferably the wheel is biased towards the down position (eg by gravity and/or a spring).

Preferably there are a plurality of landing wheels, each positioned along the centreline of the aircraft.

Preferably each landing wheel is positioned in a recess of said hull form.

Preferably at least two landing wheels are positioned in a recess of said hull form.

Preferably a plurality of recesses are provided in said hull form, at each of which at least one said landing wheel is positioned.

Preferably the recess(es) are large enough to allow the landing wheel to caster.

Preferably the fuselage includes sponsons provided to enhance stability of the amphibious aircraft when in water.

Preferably the amphibious aircraft is full time amphibious.

Preferably the amphibious aircraft comprises left and right wings dependent from said fuselage and left and right side stabilisers dependent from one of (a) said fuselage and (b) said left and right wings, each adapted and configured to hydroplane when water landing and taking off.

Preferably each stabiliser also includes a wheel able to make rolling contact with land when the aircraft is travelling over land.

Preferably the wheel is mounted in a manner to be able to caster when in rolling contact with land.

Preferably each stabiliser is in rigidly fixed to one of (a) said fuselage and (b) said left and right wings.

Preferably each stabiliser is always presented for water and land landing and take-off.

Preferably the aircraft is certified with a maximum gross take-off weight of no more than 1200 kg.

Preferably the aircraft is certified with a maximum gross take-off weight of no more than 1000 kg.

Preferably the aircraft is a 4 seater aircraft.

Preferably the aircraft is certified with a maximum gross take-off weight of no more than 1000 kg.

Preferably the aircraft is certified with a maximum gross take-off weight of no more than 800 kg.

Preferably the aircraft is certified with a maximum gross take-off weight of no more than 700 kg.

Preferably the aircraft is certified with a maximum gross take-off weight of no more than 650 kg.

Preferably the aircraft is a 2 seater aircraft.

Preferably the hull form provides all the needed buoyancy to float the aircraft in fresh water at any of these maximum take-off weights.

Preferably the hull form includes the sponsons.

Preferably hull form includes a bow and a stern.

Preferably the bow has a V-shaped entry

In a further aspect the present invention may be said to broadly be an aircraft having a plurality of landing wheels each mounted in a manner able to caster so that in a cross wind approach of said aircraft to a run way, the aircraft is able to land in a crabbed condition and the landing wheels are each able to caster to roll in the track direction of the aircraft upon landing.

Preferably all said wheels are able to caster.

Preferably a plurality of caster assemblies are provided secured so the fuselage of said aircraft and each mounting at least one caster wheel in a manner to caster about a respective caster axis.

Preferably all landing wheels are positioned along the centreline of the aircraft.

Preferably castering of said wheels is passive.

Preferably at least the wheel rear most of the aircraft is able to be actively braked.

Preferably each wheel is able to be braked, the braking occurring in a progressive or graduated manner with each successive wheel front to back being subjected greater braking force.

Preferably progressive or graduated braking caused the aircraft to de-crab during landing and after touch-down of the landing wheels.

Preferably the wheels are coupled to each other to caster in unison.

Preferably the landing wheels are always presented for landing on land.

Preferably the landing wheels do not move between a retract and deployed position.

Preferably the aircraft is an amphibious aircraft.

Preferably the aircraft is an amphibious aircraft as herein described.

In a further aspect the present invention may be said to broadly be landing gear of or for an aircraft comprising:—

at least two trucks placed in-line with the longitudinal direction of the fuselage of said aircraft each truck provided with at least one wheel presentable relative to the fuselage to make rolling contact with ground to at least partly support the weight of the aircraft,

a steering input engagement mechanism to selectively couple with at least one wheel to assist with the directional control of said aircraft whilst moving over the ground,

wherein at least the forward most wheel is mounted to be able to caster about a caster axis, when in rolling contact with the ground.

Preferably the coupling of the engagement mechanism with the wheel is by indirect engagement with the wheel.

Preferably the fuselage includes a recess at the underside of the fuselage of said aircraft for each of said trucks and engagement mechanism, to house each of the truck and engagement mechanism in said housing.

Preferably the wheel in part of a caster wheel assembly that holds said wheel in a manner able to turn about its own axis of rotation and that includes a caster axle mounted relative said fuselage for rotation about a caster axis that lies in a plane to which the axis of rotation of the wheel is normal to.

Preferably the plane is coincident the longitudinal axis of the aircraft.

Preferably the caster axis is coaxial the caster axis.

Preferably at least the forward most wheel is able to caster about a caster axis substantially perpendicular to said longitudinal axis of said aircraft.

Preferably the engagement mechanism is able to couple with said wheel(s) to control rotation of the wheel(s) about the caster axis only when the aircraft rudder is in a position that would cause the aircraft to travel in the same direction in the air as the wheels would when in rolling contact with the ground.

Preferably the engagement mechanism so couples with the wheel when at least some of the aircraft's weight is being borne by the wheel.

Preferably the engagement mechanism is not coupled with the wheel when the aircraft is airborne.

Preferably one truck of said at least two trucks is placed towards the forward end of said fuselage and the other truck placed more towards the rear end of said fuselage.

Preferably each wheel of each truck is mounted to be able to caster when in rolling contact with said ground.

Preferably the wheel(s) are controlled for rotation about their caster axis by pilot input control to steer the aircraft when the engagement mechanism is coupled to the or each wheel.

In a further aspect the present invention may be said to broadly be landing gear to assist in landing of an aircraft on ground comprising:—

a set of trucks substantially placed in-line with the longitudinal direction of the fuselage of said aircraft,

each truck provided with at least one caster wheel assembly comprising at least one wheel that is capable of castering when in rolling contact with ground,

wherein one truck of said set of trucks is substantially placed towards the forward end of said fuselage and the other truck of said set of trucks is substantially placed towards the rear end of said fuselage,

wherein as the aircraft comes into land when the nose of the aircraft is higher than the rear of the aircraft, then the one or more wheels of said rear truck can caster to become aligned to the aircraft track, followed by the one or more wheels of said front truck as its wheel or wheels contact the ground, to allow the aircraft to land and travel on the ground in a crab condition.

Preferably for each truck, the wheels are connected in a manner to caster in unison.

Preferably when said aircraft is in-flight then its heading is substantially controlled by the rudder and air flow over the wings generated by said aircraft engine, jet engine, propeller or the like.

Preferably when in-flight, each wheel is able to freely caster about its respective axis through a 360 degrees.

Preferably when in-flight, each wheel is able to freely caster about its respective axis but limited to a range of rotation of less than 360 degrees.

Preferably free caster movement of the wheels or angle of rotation of each wheel can be limited by for example a spring(s) (including pneumatic, leaf for example), locking arms, brakes, shock absorber(s), bellow(s), dampers, stops or other apparatus capable of preventing the movement and/or shimming of the wheels.

In some embodiments this apparatus capable of preventing movement and/or shimming of the wheels can be provided directly or indirectly to the wheels, the trucks and/or a mount located between said set of truck(s) and fuselage of said aircraft.

In an embodiment when said aircraft is on and travelling over the ground then directional control of said aircraft is primarily assisted by landing gear apparatus which may or may not be further assisted by control of the rudder and/or air flow over the rudder and/or wings generally used for directional control while in-flight.

The engagement mechanism can be automatically or manually controlled (eg by the pilot) of the aircraft. In one embodiment the engagement mechanism is automatic.

In an embodiment the landing gear is attached to amphibious, seaplanes or land only aircraft.

In some embodiments a set of trucks is at least 2 or more and a set can be an uneven number of trucks. In some embodiments the trucks comprise 2 or more sets of wheels. The wheels can be singular or more width wheels. Each set can comprise even or uneven sets of wheels, such as for example, a pairing of 1 or 2 wheels, a pairing of 1 and 3 wheels, a pairing of 2 wheels and 3 wheels, a pairing of 2 and 5 wheels, 3 and 7 wheels. The wheels can contain air, such as the conventionally used aircraft tyres or be airless, such as tweels.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

As used herein the term “and/or” means “and” or “or”, or both.

As used herein the term “(s)” following a noun includes, as might be appropriate, the singular or plural forms of that noun.

### BRIEF DESCRIPTION OF THE DRAWINGS

Preferred forms of the present invention will now be described with reference to the accompanying drawings in which,

FIG. 1 is a perspective view of an aircraft carrying landing gear as will herein after be described,

FIG. 2 is an alternative perspective view of the aircraft of FIG. 1,

FIG. 3 is an alternative perspective view of an aircraft of FIG. 1,

FIG. 4 is a plan view of an aircraft with parts highlighted and/or removed for the purposes of illustrating the landing gear configuration,

FIG. 5 is a side view of a caster assembly and mount, being the or comprising of part of the landing gear for the aircraft,

FIG. 6 shows a caster assembly in a different format to that of FIG. 5 with certain components removed for clarity,

FIG. 6A is a plan vied of an aircraft wherein its landing gear includes a front caster assembly and a fixed rear wheel which axis of rotation remains perpendicular to the centreline of the aircraft,

FIG. 6B is a plan view of the landing gear of the aircraft shown in FIG. 6A,

FIG. 7 illustrates the landing gear in a preferred form comprising of front and rear landing gear assemblies, preferably in the form of front and rear trucks each carrying three in-line caster wheels,

FIG. 8 is an alternative perspective view of the configuration shown in FIG. 7,

FIG. 9 is a perspective view of the configuration in FIG. 7 with certain components removed for clarity,

FIG. 10 is a plan view of the configuration of FIG. 7,

FIG. 11a is a plan view of an aircraft in a condition where the wheels of the rear landing gear truck have made contact with a runway, the aircraft coming into land in a crabbed condition,

FIG. 11b is a plan view of the landing gear trucks with wheels in a rotational position as they would be on the aircraft in the condition as shown in FIG. 11a,

FIG. 11c is a side view of a caster wheel of the front landing gear truck in a rotational position as it would be when an aircraft is in a condition as shown in FIG. 11a,

FIG. 11d is a side view of a wheel of the rear landing gear truck in a rotational position at it would be with an aircraft shown in the condition as in FIG. 11a,

FIG. 12a is a plan view of an aircraft where the wheels of both the front and rear landing gear trucks are in contact with the runway and where the aircraft has landed in a crabbed condition,

FIG. 12b is a plan view of the front and rear landing gear trucks with wheels in a rotational position as they would be on the aircraft in the condition as shown in FIG. 12a,

FIG. 12c is a side view of a caster wheel of the front landing gear truck in a rotational position as it would be when an aircraft is in a condition as shown in FIG. 12a,

FIG. 12d is a side view of a wheel of the rear landing gear truck in a rotational position as it would be with an aircraft shown in the condition as in FIG. 12a,

FIG. 13 is a perspective view of a caster wheel and caster wheel mount,

FIG. 14 illustrates a caster assembly,

FIG. 15 is a side view of a caster assembly mounted with its caster axle bearings,

FIG. 16 is a front view of FIG. 15,

FIG. 16a is a close up view showing the caster assembly in a down condition relative to the caster axle bearings,

FIG. 17 illustrates the caster assembly together with the steering block,

FIG. 18 is an alternative view of that of FIG. 17 and showing the caster wheel assembly in an up condition wherein the caster assembly is coupled for rotation to and with the steering block,

FIG. 19 is a view of the caster assembly, the steering block together with its steering arm,

FIG. 19A is a schematic plan view of a foot pedal steering input, front wheel and rudder assembly of an aircraft coming in to land in a crabbed condition, prior to the wheel illustrated making contact with the ground,

FIG. 19B is a side view of a wheel in the condition shown in FIG. 19A

FIG. 19C is a schematic plan view of a foot pedal steering input, front wheel and rudder assembly of a taxiing aircraft travelling at a crab angle,

FIG. 19D is a side view of a wheel in the condition shown in FIG. 19C,

FIG. 19E is a schematic plan view of a foot pedal steering input, front wheel and rudder assembly of an a taxiing aircraft travelling in a straight line,

FIG. 19F is a side view of a wheel in the condition shown in FIG. 19E

FIG. 20 is a side view of the assembly shown in FIG. 19,

FIG. 21 is a perspective view of the caster assembly together with the caster wheel mount and wherein the caster assembly is shown in a down condition,

FIG. 22 shows the caster assembly in an up condition wherein the caster assembly is coupled for rotation to and with the steering block,

FIG. 23a shows an aircraft in a taxiing condition and where the wheels of the front and rear landing gear trucks are positioned to cause the aircraft to turn left,

FIG. 23b is a plan view of the front and rear landing gear trucks with wheels in a rotational position as they would be on the aircraft in the condition as shown in FIG. 23a,

FIG. 23c is a side view of a caster wheel of the front landing gear truck in a rotational position as it would be when an aircraft is in a condition as shown in FIG. 23a,

FIG. 23d is a side view of a wheel of the rear landing gear truck in a rotational position as it would be with an aircraft shown in the condition as in FIG. 23a,

FIG. 24 is a schematic view showing the wheels of the front and rear landing gear trucks angled relative to the fuselage to illustrate the differential steering of the aircraft by having each of the wheels positioned at a different angle to the heading direction H of the aircraft when the aircraft is taxiing and turning,

FIG. 25a shows part of the front landing gear truck wherein the rudder/steering mechanism of the aircraft is set full left and the caster assemblies have castered right to a position the aircraft heading is at 30 degrees to the runway/track as for example shown in FIG. 11a,

FIG. 25b is an alternative view of FIG. 25a, in both views of which the caster assemblies are free from steering input control,

FIG. 26a is a perspective view of part of the rear landing gear trucks where each of the caster assemblies are set in their up position engaged with respective steering blocks for steering input control,

FIG. 26b is an alternative view of that of FIG. 26a,

FIG. 27 is a perspective view of part of the rear landing gear truck and illustrating the provision of expansion and contraction joints as part of the parallelogram mechanism that may be required for the purposes of making the differential steering mechanism and the parallelogram mechanism compatible with each other,

FIG. 28A is a perspective view of part of a landing gear truck showing the provision of a wheel centering construction,

FIG. 28B shows a plan view of the wheel centering construction and rotation limiting stops, where the caster limiting pin is presented in an up condition for contact with the rotation limiting stops,

FIG. 28C is a side view of FIG. 28B,

FIG. 28D shows a plan view of the wheel centering construction and rotation limiting stops, where the caster limiting pin is presented in a down condition for contact with the centering members,

FIG. 28E is a side view of FIG. 28D,

FIG. 29 is a close up view of parts of the components shown in FIG. 28,

FIG. 30 is a side partial see through view of the aircraft illustrating the front and rear landing gear trucks,

FIG. 31-33 show the front and rear landing gear trucks in various relative conditions to each other,

FIG. 34 is a side view of the aircraft in partial see through view showing the rear landing gear truck and its suspension arm mechanism,

FIG. 35 is a schematic view of the rear landing gear truck and its suspension mechanism,

FIG. 36 is a partial plan view of a landing gear truck illustrating a motor coupled to two of the three wheels of the truck,

FIG. 37 is a perspective view of the arrangement of FIG. 36,

FIG. 38 shows a bottom perspective view of an aircraft with wheels of each of the landing gear trucks set up, but protruding from the hull form of the preferred amphibious version of the aircraft,

FIG. 39 is a partial side and see through view of an aircraft with wheels of each of the landing gear trucks set up, but protruding from the hull form of the preferred amphibious version of the aircraft,

FIG. 40 shows a rear view of an aircraft with a wheel set up in yet protruding from the hull form of the preferred amphibious version of the aircraft.

### DETAILED DESCRIPTION OF THE INVENTION

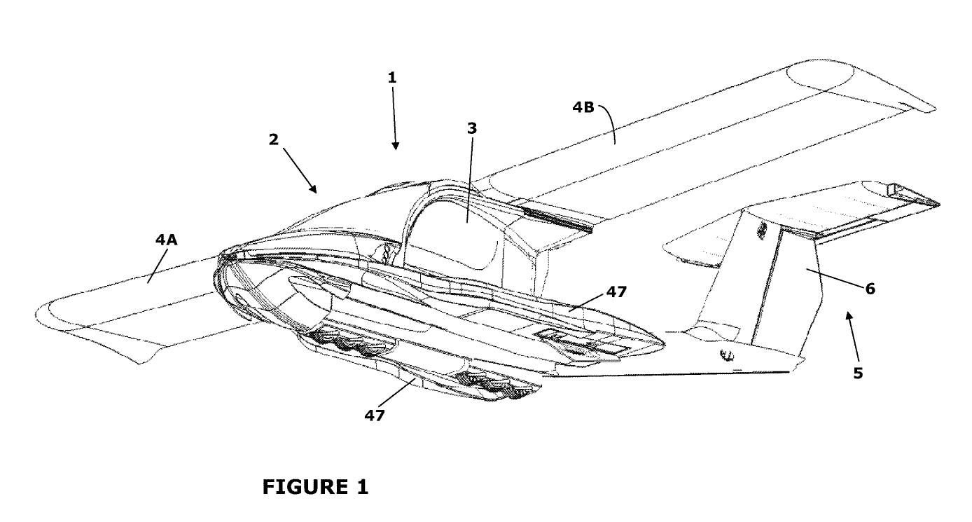

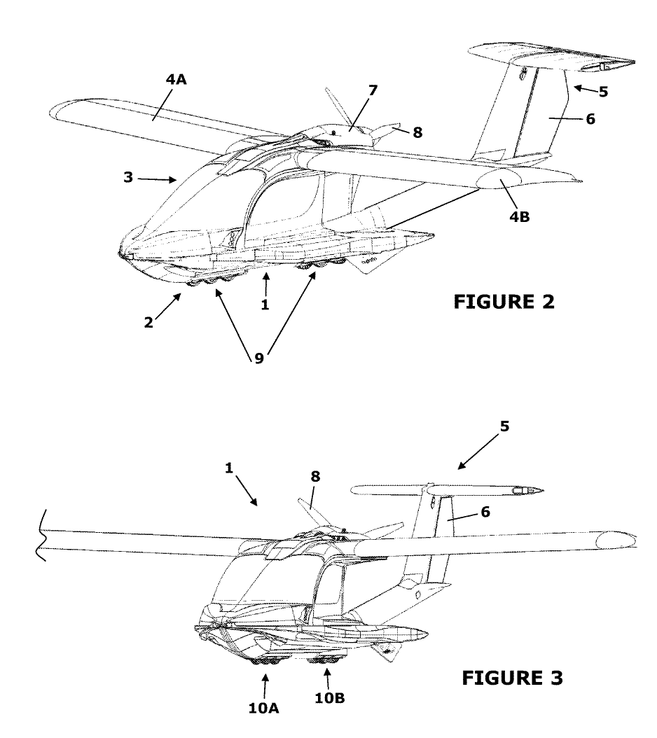

The present invention relates to an aircraft that in one form has landing gear that allows the aircraft to land on land. An example of an aircraft 1 that may carry landing gear as herein described is shown in FIG. 1. In one form the aircraft is an amphibious aircraft capable of landing on both water and land. However in some forms the aircraft and its landing gear are configured for landing on land only.

The aircraft 1 preferably comprises of a fuselage 2 that includes a cockpit region 3 able to carry a pilot and preferably also at least one and preferably a plurality of passengers. The aircraft also includes primary wings 4a and 4b that may carry appropriate control surfaces (eg ailerons and flaps). The aircraft may also be configured to have a tail wing assembly 5 that may carry appropriate control surfaces such as elevator and rudder control surfaces. A rudder 6 is for example shown in FIG. 1. The aircraft has a longitudinal axis, vertical axis and lateral axis, being common aircraft nomenclature. The fuselage is elongate and extends along the longitudinal axis of the aircraft. The fuselage is preferably substantially of a composite material.

The wings or fuselage may carry at least one motor 7 that may directly or indirectly drive a propeller 8 or propellers. The control surfaces of the aircraft are able to be controlled by pilot input. For example the rudder 6 may be operable via a linkage mechanism connected to a foot pedal mechanism 45 in the cockpit. The foot pedal mechanism can cause the rudder 6 to turn left and right.

Landing gear 9 is preferably presented at the underside of the fuselage. In a basic form the landing gear of the aircraft comprises of at least one wheel. This at least one wheel is the main weight bearing wheel for when the aircraft is on land. It can support the aircraft on land. Other wheels like it or other support providing members may also be provided to help support the aircraft on land.

In examples of the aircraft shown herein, a plurality of wheels are described. However, in a basic form the landing gear may present only one wheel, that wheel preferably able to caster in a manner as will herein be described.

The provision of one or more wheels able to caster allows the aircraft to land on land in a condition where its heading is not parallel to its track. Eg, it is approaching a runway in a crabbed condition. Such a situation may for example be encountered when an aircraft is landing on a runway and is subjected to a cross wind. The ability for the wheel(s) of the landing gear to caster allows for a or each wheel to contact the runway and caster (eg be pivoted, preferably about a substantially vertical axis) so that a or each wheel's rotational axis is caused to move to a position that is perpendicular to the track of the aircraft. This allows the aircraft, upon landing to remain in a crabbed condition. The wheel(s) will roll on land so that their operative rolling direction is the same as the aircraft's track. This may not be the same direction as the aircraft's heading. De-crabbing of an aircraft landing in a crabbed condition may occur in a gradual manner, whilst in contact with land, as will herein after be explained.

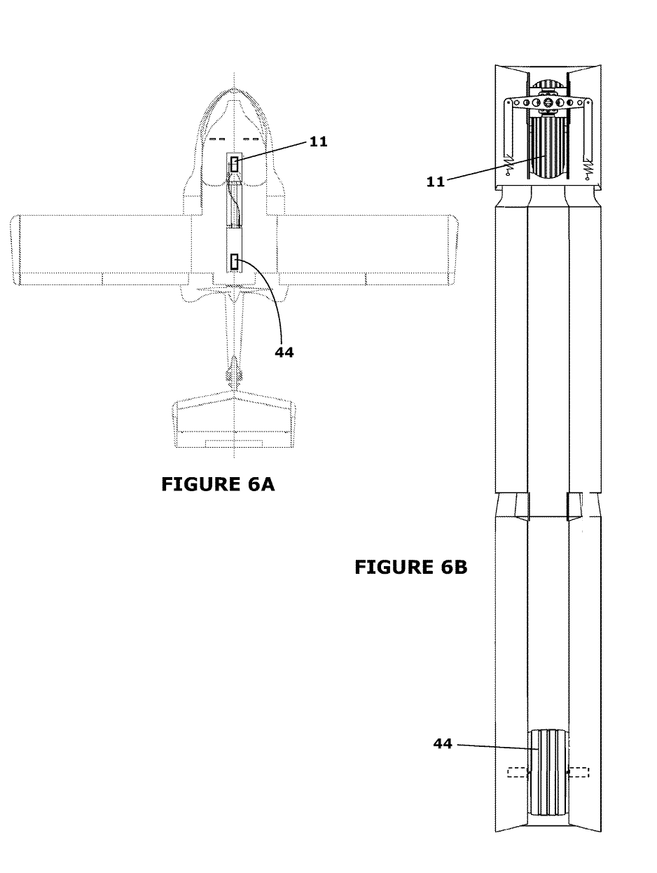

Whilst in one form the aircraft herein described may carry a landing gear comprising of only one wheel that is able to caster as seen in FIGS. 6A and 6B, in a more preferred form the aircraft carries a plurality of wheels at least two and preferably all of which are able to caster. The casterable wheel or wheels is/are the main load bearing wheels for the aircraft.

In a preferred form the landing gear 9 of the aircraft 1 comprises of at least a forward more and a rearward more positioned wheel. Preferably the forward more positioned wheel is forward of the aircraft's CoG and the rearward more positioned wheel is rear of the aircraft's CoG. Preferably there are two sets of wheels engaged to the fuselage, one forward more and one rearward more.

Preferably each set of wheels is provided as part of a landing gear truck formation. There being a front landing gear truck 10a and a rear landing gear truck 10b. Landing gear truck 10a is forward more positioned to the fuselage compared to rear landing gear truck 10b.

Each landing gear truck 10a and 10b carries at least one wheel which is preferably mounted in a manner able to caster relative to the fuselage. In the most basic form it is preferably the wheel or wheels of the front truck that are able to caster when there is only one wheel of the rear landing gear truck 10b. However in the preferred form the wheel or wheels of each truck 10a, 10b are mounted in a manner to be able to caster relative to the fuselage.

In one form the front and rear landing gear trucks carry an equal number of wheels. In other forms that are also herein described the front landing gear truck 10a may carry fewer wheels than the rear landing gear truck 10b.

In the preferred form the wheels are all in-line (though may not be castered in alignment). Preferably the wheels are all positioned along a vertical plane passing through the longitudinal axis of the aircraft.

When the aircraft is travelling on land the ability for the wheel or wheels to caster relative the fuselage is limited and dictated at least by virtue of contact of the wheels with the ground. When the aircraft is in the air the wheels are able to freely caster although as will hereinafter be described such castering whilst the aircraft wheels are not in contact with the ground may in other ways, at least to some extent, be limited.

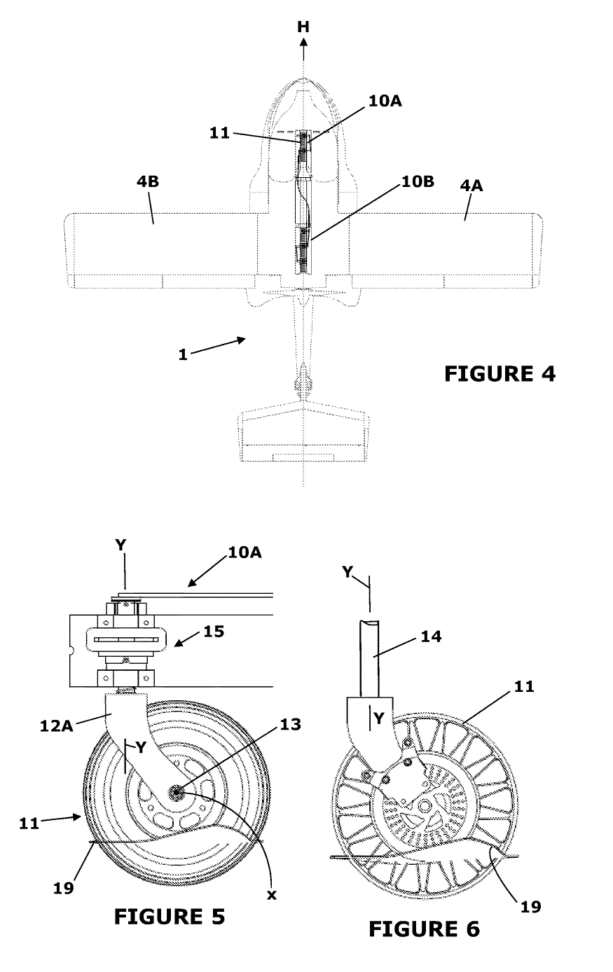

With reference to FIG. 5 a caster assembly presenting a wheel 11 is shown. The wheel may be a pneumatic wheel as for example shown in FIG. 5 or it may be an airless wheel as shown in FIG. 6. The wheel is mounted for revolution about its axis X. When the aircraft is travelling on land and its heading H and track coincide the axis X of the wheel is perpendicular to the heading H. The heading H corresponds to the centreline of the aircraft. As seen in FIG. 4 the front most wheel 11 is aligned with the heading H.

The wheel 11 is mounted for revolution about its rotational axis X by the caster assembly. More than one wheel may be mounted by said caster assembly, each wheel mounted for revolution on a common rotational axis. The caster assembly includes mounting arms 12a and 12b that carry the axle 13 of the wheel, on each lateral side of the wheel. The mounting arms are mounted for rotation around a castering axis YY to allow the wheel to caster relative to the fuselage of the aircraft about the castering axis YY. A caster axle 14 (sometimes also referred to in the art as the caster spindle) may be provided to facilitate such castering. There could be just one arm 12a and no arm on the other side of the wheel. The castering axle 14 is mounted in a manner that will hereinafter be described.

In the preferred form the castering axis YY is oriented substantially vertically relative to the aircraft when it is in a horizontal condition. The axis YY is preferably normal to the surface that the wheel is travelling on, when the aircraft is on land.

In the preferred form the castering axis YY lies in the vertical plane of the aircraft that passes through the longitudinal axis of the aircraft.

However in some forms aircraft may carry caster assemblies that are set side by side rather than in-line. The castering axis are preferably parallel the vertical plane.

The caster axle 14 is mounted by or via a caster wheel mount 15 that will hereinafter be described in more detail.

The castering axis YY for each wheel is preferably positioned in a more forward position of the aircraft compared to the wheel axis X. The castering axis YY preferably does not pass through the wheel axis. In use the castering assembly is configured to set up a positive caster condition when the aircraft is travelling forwards on land.

Whilst in the preferred form a caster assembly as for example shown in FIG. 5 is part of a landing gear truck such as the front landing gear truck 10a, in other forms envisaged the caster assembly may be directly mounted to the fuselage without being mounted as part of a truck. In one form the truck may be directly mounted to the fuselage of the aircraft and be held rigid thereto and in other forms and as more preferred (and will hereinafter be described) the truck is able to move with some degree of freedom relative to the aircraft fuselage.

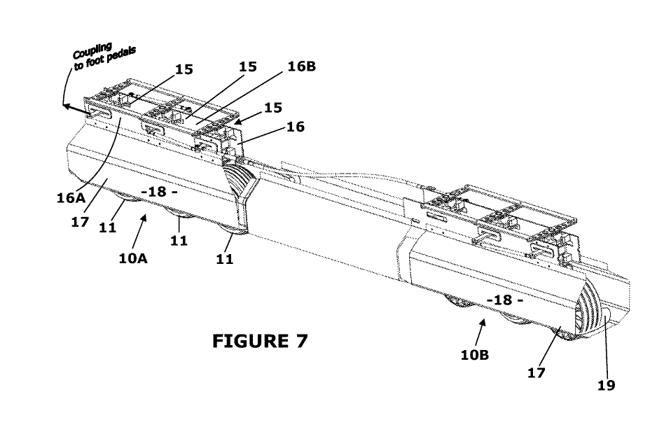

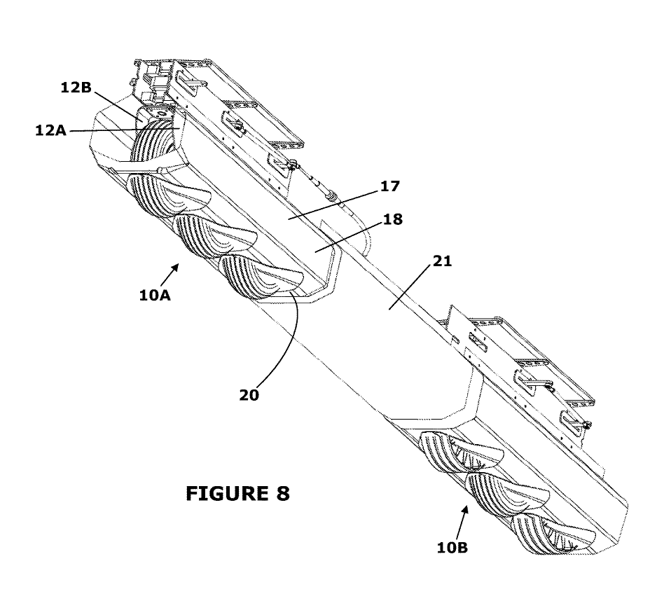

With reference to FIG. 7 an example of the front and rear landing gear trucks 10a and 10b are shown in more detail. The front landing gear truck 10a may comprise of three wheels 11 each mounted to a beam assembly 16 by way of respective caster assembly mounts 15. The beam assembly 16 holds the caster assembly mounts 15 in a condition such that each of the wheels 11 of the front landing gear truck 10a (and this also applies to the rear landing gear truck 10b), have their respective castering axis in a fixed disposition relative to each other. Preferably the castering axis of each of the caster axles of a respective truck are parallel each other.

Where the landing gear is provided on an amphibious version of the aircraft, each truck 10a and 10b preferably includes or is located in a housing 17 substantially within which each of the wheels is positioned. The housing is provided to help facilitate with the hydrodynamics of the hull form of the amphibious version of the aircraft as a result of the housing presenting itself in a manner to (a) reduce the ingress of water into the housing and (b) reduce contact with the wheels whilst the aircraft is moving on water and (c) provide some of the hull form surface(s) that facilitate hydroplaning for the aircraft.

The housing 17 preferably includes a hard shell 18 and a shroud such as in the form of a compliant membrane 19 that can help, as best as possible, bridge the gap between the hard shell 18 and each respective wheel. The compliant membrane 19 is able to flex and deform as may be necessary when a wheel turns about its respective castering axis, yet remain relatively close if not presses against a respective wheel to help prevent water entering the cavity of the housing. It may not stop water entering at rest but helps prevent water entering when the aircraft is landing at speed and in water.

In the preferred form each wheel projects partially through the mouth opening 20 of the hard shell 18 of the housing 17 and as such the mouth opening is sufficiently sized to accommodate the wheel in its range of rotational caster positions. The hard shell may define one mouth opening for each of the wheels or may provide a plurality of mouth openings one for each of the wheels.

When the wheels are free to caster the compliant membrane may, to some extent, bias the wheel or wheels to a particular rotational position. This may for example be to a position where the wheel or wheels are aligned to the elongate axis of the aircraft. A compliant membrane may act analogous to a spring to bias the wheels to a preferred rotational caster position.

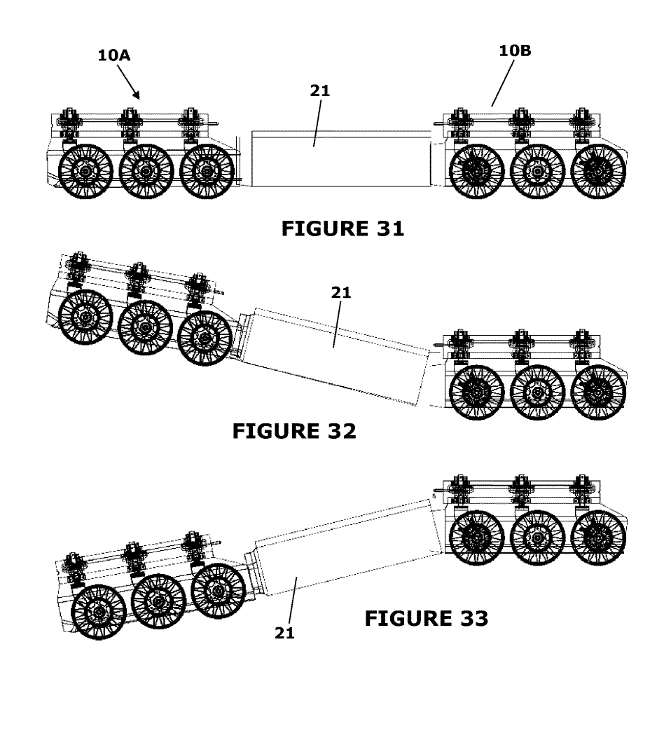

A bridge member 21 may be provided extending between (and preferably articulatable relative to) each of the front and rear landing gear trucks 10a and 10b. Such articulation is for example shown in FIGS. 31 to 33. Despite such articulation preferably the castering axes of all of the wheels of the landing gear all remain in the elongate axis coincident vertical plane of the aircraft.

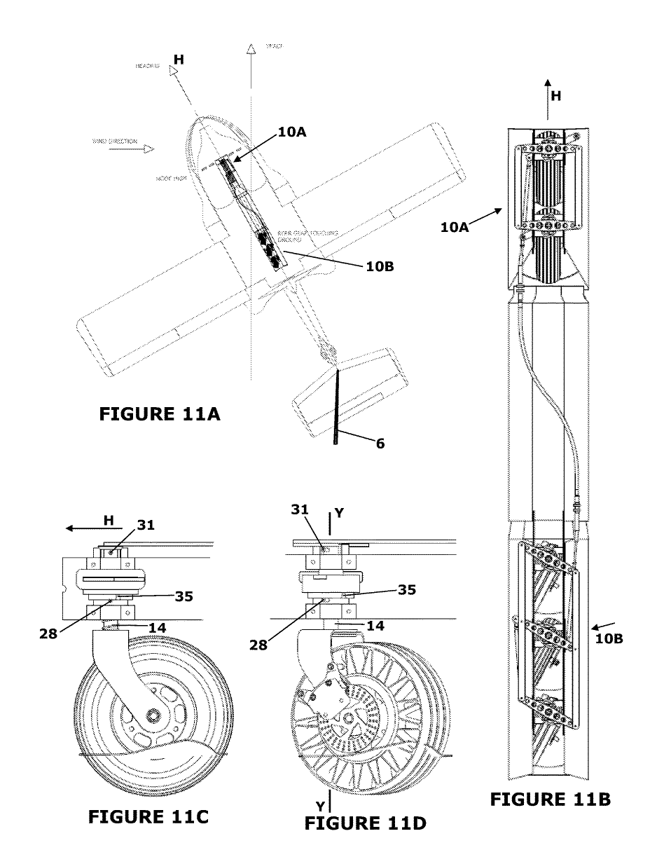

Reference will now be made to FIGS. 11a-d. This reference is made for the purposes of explaining the reason why a wheel and preferably all of the wheels of the landing gear are able to caster. FIG. 11a is a plan view of an aircraft approaching a runway and having touched down with the wheels of the rear landing gear truck 10b. The aircraft is shown flying on a track that is ideally aligned to the runway. The aircraft illustrated is flying at a crab angle due to a cross wind also as illustrated. The aircraft is preferably landed in a condition where the wheels of the rear landing gear truck touchdown onto the ground first. By being free to caster the wheel or wheels of the rear landing gear truck, upon making contact with the ground, can rotate to a position where the rotational axes are perpendicular to the track of the aircraft. The wheels are free to caster to this position. FIG. 11c shows the wheel of the front landing gear truck in a position not aligned to the track of the aircraft whereas FIG. 11d shows a wheel of the rear landing gear truck having rotated about its axis YY to align to the track of the aircraft.

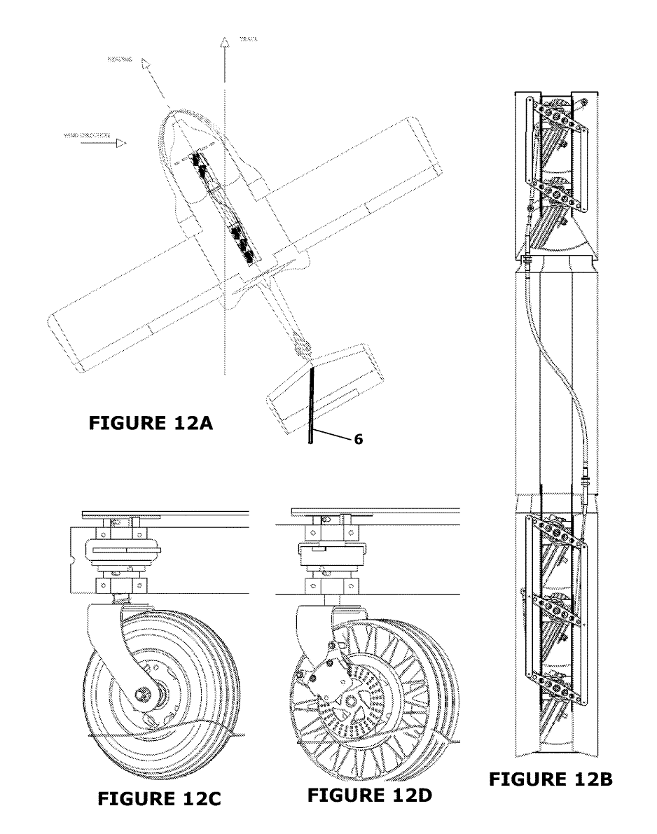

FIGS. 12a-12d show a condition of the aircraft where it is positioned with the wheels of both landing gear trucks engaged to the ground. The wheels of the front landing gear truck as well as the wheels of the rear landing gear truck are aligned to the track. Again, when landing, a contact of the wheels of the front landing gear truck with the ground causes the wheels to caster and be aligned in a manner so that the rotational axis or axes of the front wheel or wheels are perpendicular to the track of the aircraft. This is preferably aligned to the direction of the runway.

The ability for the wheels to so caster improves the safety for aircraft operation. A pilot landing an aircraft in a crab position relative to a runway is able to maintain the crab position during the final approach to the runway, this enables less pilot workload and lowers the risk of loss of control on final approach. The aircraft after touchdown self aligns with the track (runway) meaning that no pilot input is required to correct the aircrafts position prior to touching down, this is especially important as this occurs in close proximity to the ground

Whilst in some forms each of the casterable wheels are independently and individually able to caster, in a more preferred form at least pairings of caster assemblies are coupled. This may help reduce the prospect of caster wobble. By connecting caster assemblies at least in pairs, caster wobble is less likely to occur. In the preferred form more than two caster assemblies are so coupled. Preferably all of the wheels of a landing gear truck are connected for the purposes of reducing the prospect of caster wobble.

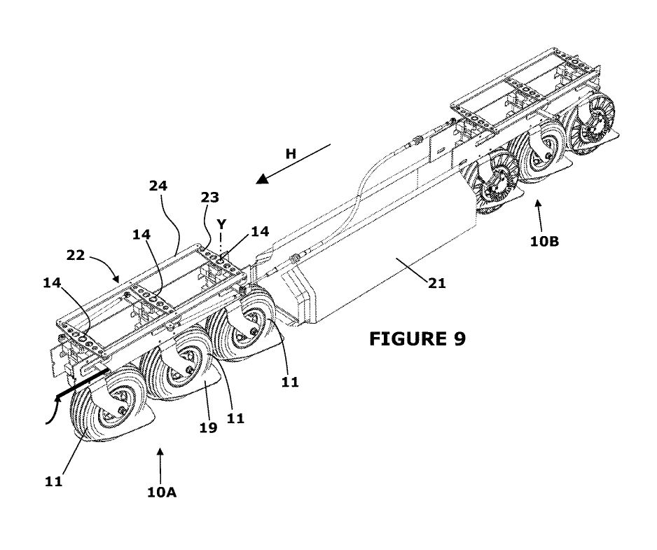

With reference to FIG. 9 it can be seen that a parallelogram linkage 22 is provided for these purposes. Preferably each caster axle 14 is secured to an arm 23. The arm 23 extends radially at least in one and preferably opposed directions relative the caster axis YY. When extending in opposed directions relative the caster axis YY, each arm, at its distal ends is coupled to a respective link bar 24. The coupling is preferably a pivotal coupling. For each wheel of a landing gear truck there are preferably two link bars 24 one on each side as can be seen in FIG. 9. The link bar is coupled to a distal end of each of the arms 23 equi-distant from a respective castering axis YY. The arms 23 and link bars 24 will cause each of the wheels to turn about their respective caster axis in unison. Should for example one of the wheels of a landing gear truck be prone to caster wobble such wobble is restrained by the other wheels via the arms 23 and link bars 24. Caster wheel wobble may also to some extent be reduced by virtue of the compliant membrane 19 of each of the wheels. Other mechanism may be employed to reduce caster wobble.

Upon a touchdown onto a runway by of one of the wheels of a landing gear truck, the arms 23 and link bars 24 will cause castering rotation of that first wheel to touch on the runway to be transferred to the other wheels of the landing gear truck. This means that such other wheels are pre-aligned for touchdown.

Preferably the caster axle 14 passes through the caster assembly mount 15 to present a distal end of the caster wheel axle above the caster wheel mount for and at where the arm 23 is secured.

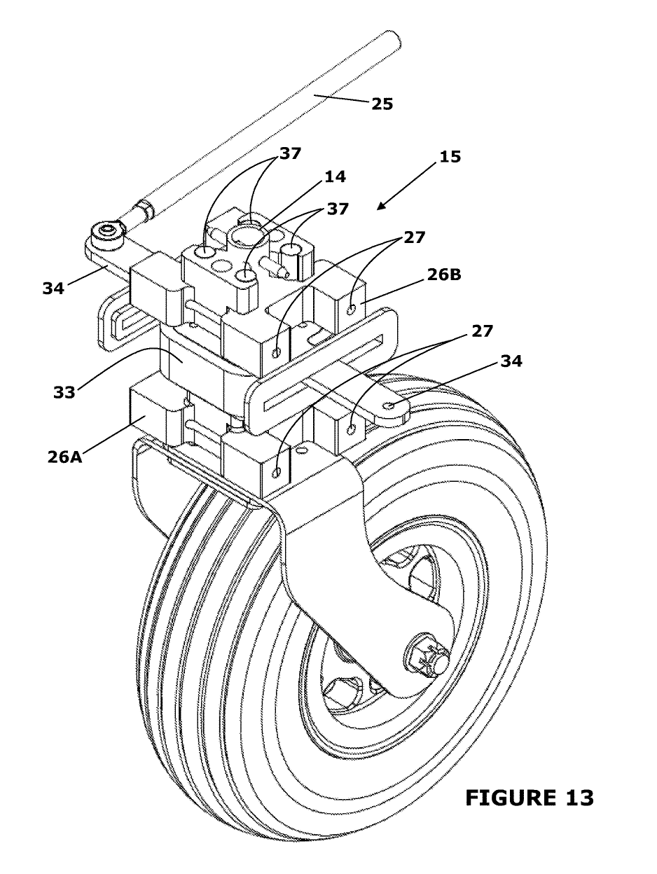

In the preferred form, as well as being able to caster preferably freely but potentially also within rotational limits, the or each wheel is also able to be controlled for steering the aircraft. The wheel as seen in FIG. 13 is able to be controlled for steering input by way of rotational control about the caster axis YY via a steering connection rod 25 that is able to be controlled by pilot input (eg by foot pedals that may also control rudder position). The caster assembly mount 15 as seen in FIG. 13 comprises of a plurality of components that facilitate this.

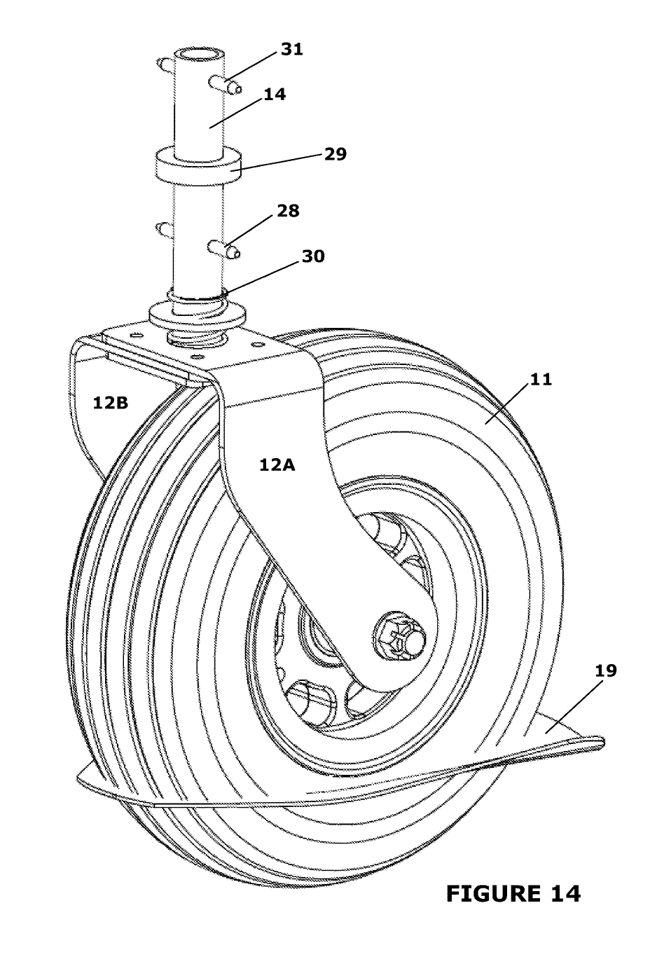

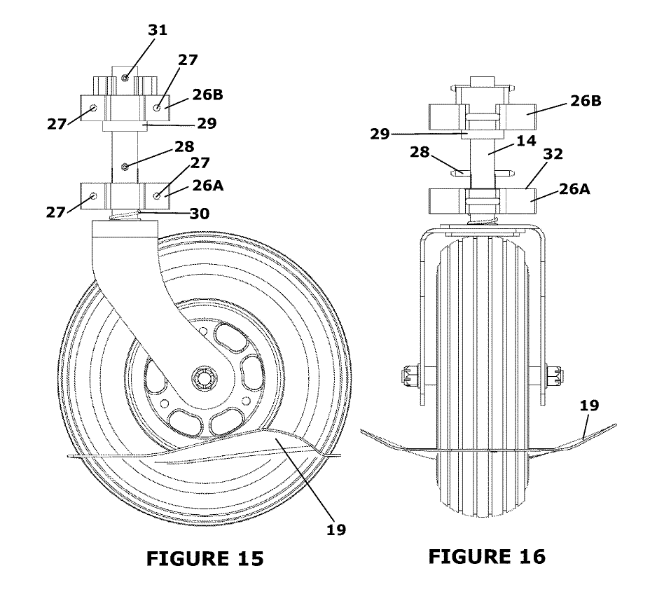

To help illustrate the construction of the caster assembly mount 15 reference will now be made to FIGS. 14-22. These figures show component parts of the caster assembly mount construction together with the caster axle and other components. FIG. 14 illustrates the wheel 11 mounted to the caster mounting arms 12a and 12b that are each in turn secured to the caster axle 14. The caster axle 14 is preferably round as this allows for it to sit within circular bearings of caster axle bearing members 26a and 26b as seen in FIG. 15. The caster axle bearing members 26a and 26b are secured or integrally formed to/with the beam assembly 16. The beam assembly may include two side members 16a and 16b to which the caster axle bearings members 26a and 26b are secured by a threaded fastener. Threaded apertures 27 of each of the caster axle bearings members may be provided for these purposes. Alternative ways of securing the caster axle bearings to the beam assembly are also envisaged.

The caster axle bearings members 26a and 26b are sufficiently spaced from each other to securely hold the caster axle in place and allow for the caster axle to rotate relative thereto about its caster axis YY. The caster axle is preferably also able to move axially relative the bearing members. This allows the wheel to move between an up condition and a down condition that will herein after be further explained.

Securely coupled or forming part of to the caster axle 14 is a steering pin 28. The steering pin preferably extends laterally to the caster axle 14 as can be seen in FIG. 14. The steering pin can allow for torque to be applied to the caster axle to cause the operative rolling direction of the wheel to be controlled. Other means of applying such torque are envisaged.

The caster axle 14 may also carry a stop 29 that is secured to the caster axle and is provided optionally for the purposes of providing a stop surface to limit the movement of the caster axle in an axial direction relative to the caster axle bearing members 26a and 26b.

A spring 30 may be provided for the purposes of biasing the wheel towards its down condition relative to the caster axle bearing members.

The caster axle may also have attached to it a caster limiting pin 31. Like the steering pin 28 the caster limiting pin may extend laterally through the caster axle 14 and be presented on each side of the caster axle for interaction with caster rotation limiting stops that will hereinafter be described. It is envisaged that the steering may be provided to limit caster.

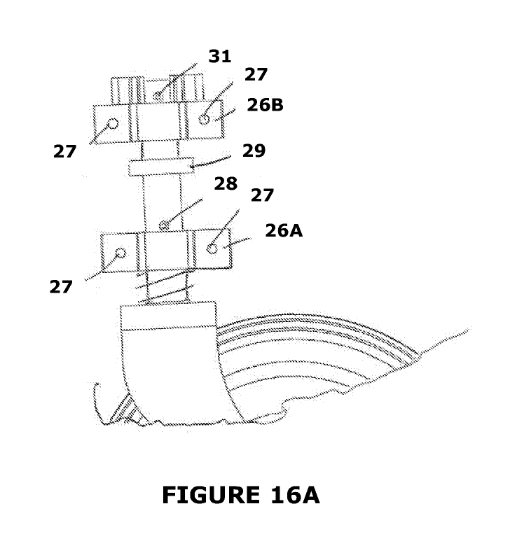

In the configuration shown in FIGS. 15 and 16 the caster axle is in an up condition, the stop 29 is pressed against a downwardly facing surface of the upper caster axle bearing member 26b and the spring is more compressed than were the caster axle in a down condition. In the down condition the steering pin 28 may rest on an upward surface 32 of the lower caster axle bearing member 26a. It may rest and be able to rotate over that upward surface 32 and that upward facing surface and the steering pin 28 will interact to prevent the caster axle from dropping further downwards. Such limit of movement may also be provided by the interaction of the caster limiting pin 31 bearing on an upwardly facing surface of the upper caster axle bearing member 26b. Alternative or additional axle axially displacement limiting stops may be provided.

FIG. 16a shows the wheel in a down condition where the caster axle is displaced downward more relative to the caster axle bearings when compared to its up condition that is shown in FIGS. 15 and 16.

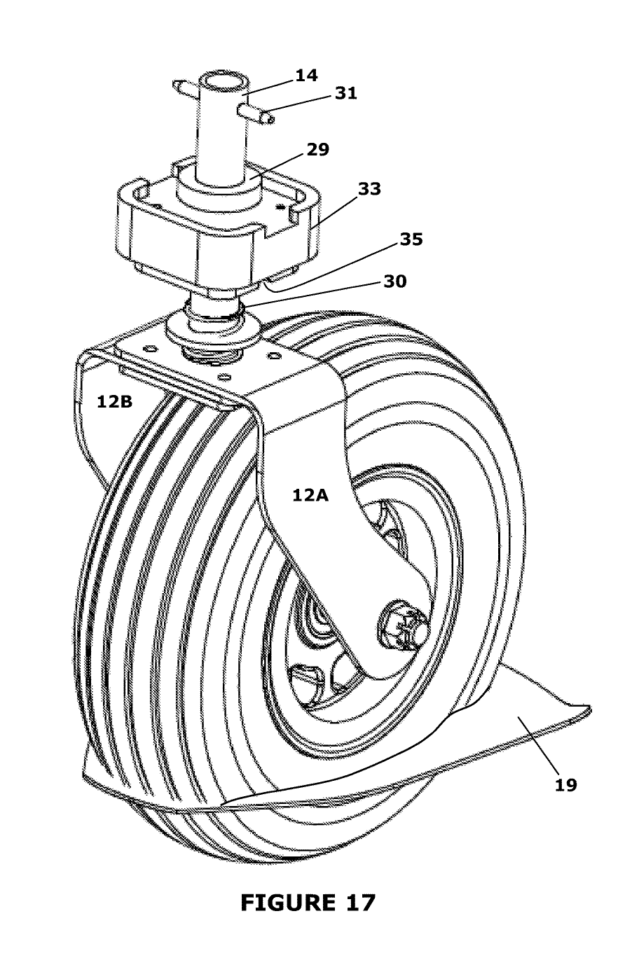

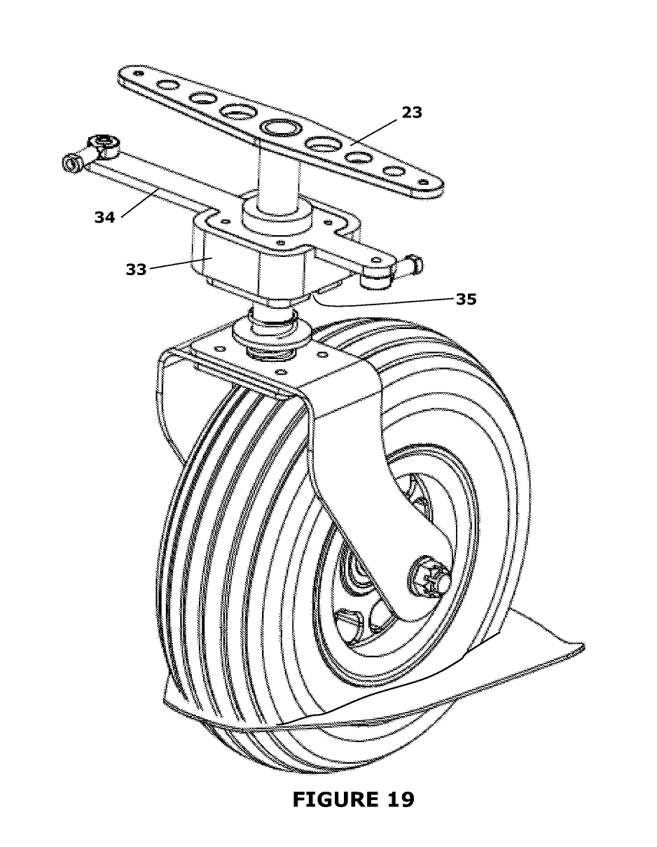

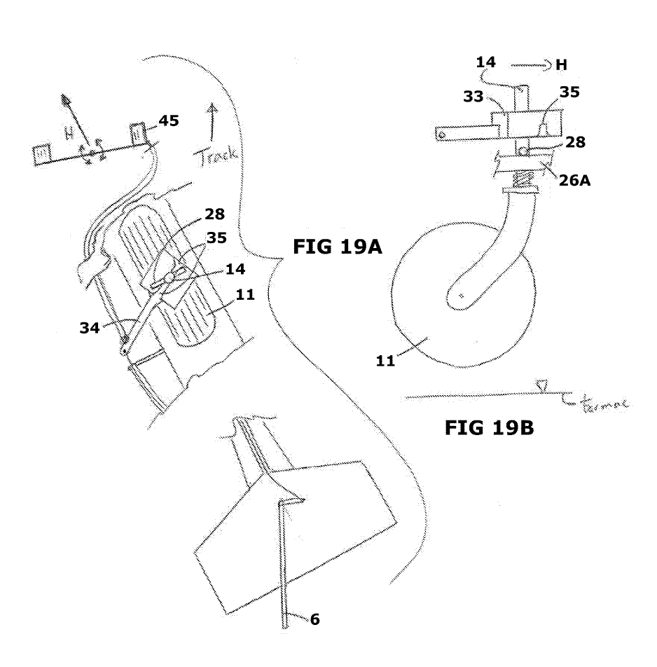

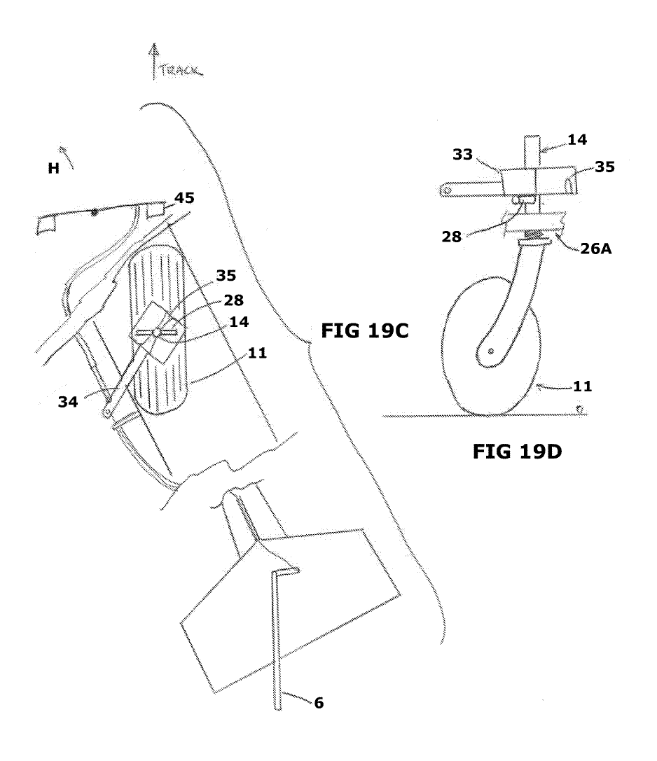

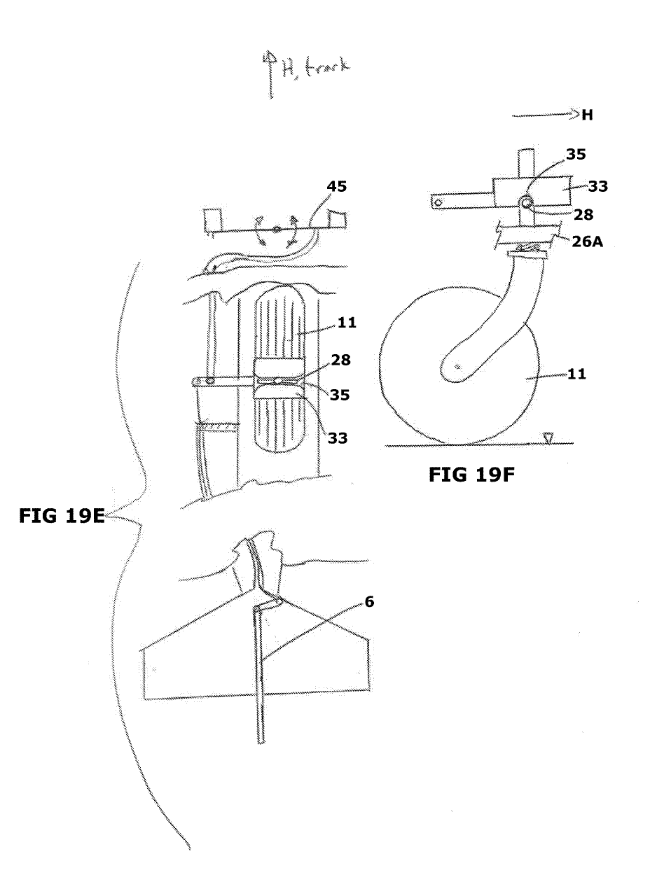

The caster assembly mount 15 also includes a steering block 33. The steering block 33 is securely connected to a steering arm 34 as seen in FIG. 19. The steering arm 34 and the steering block may be integrally formed or may be assembled from component parts. FIG. 17 illustrates the steering block 33 without the steering arm. The caster axle 14 preferably extends through the steering block that includes an aperture therethrough to snugly locate about the caster axle. The caster axle is able to travel axially relative to the steering block. The caster axle is also able to rotate relative to the steering block. The steering block can selectively couple to the caster axle (directly or indirectly) so that when coupled, torque can be applied via the steering block to the axle.

The steering arm 34 is preferably coupled to a steering connection rod 25 as can be seen in FIG. 13. Preferably the steering arm has two opposed distal ends to allow for two steering connection rods to couple to the steering arm 34. This can allow for push/pull forces to be applied to the steering arm via two steering connection rods. The steering connection rods can cause the steering block via the steering arms to rotate about the caster axis YY. Pilot steering input can control the steering block rotational position. Preferably the same input control also controls the rudder.

In the preferred form the steering block 33 is mounted in a manner to not travel up and down relative to the caster axle bearing members 26a and 26b. Preferably the steering block is held and prevented for movement, other than for rotation about the caster axis, relative the beam assembly.

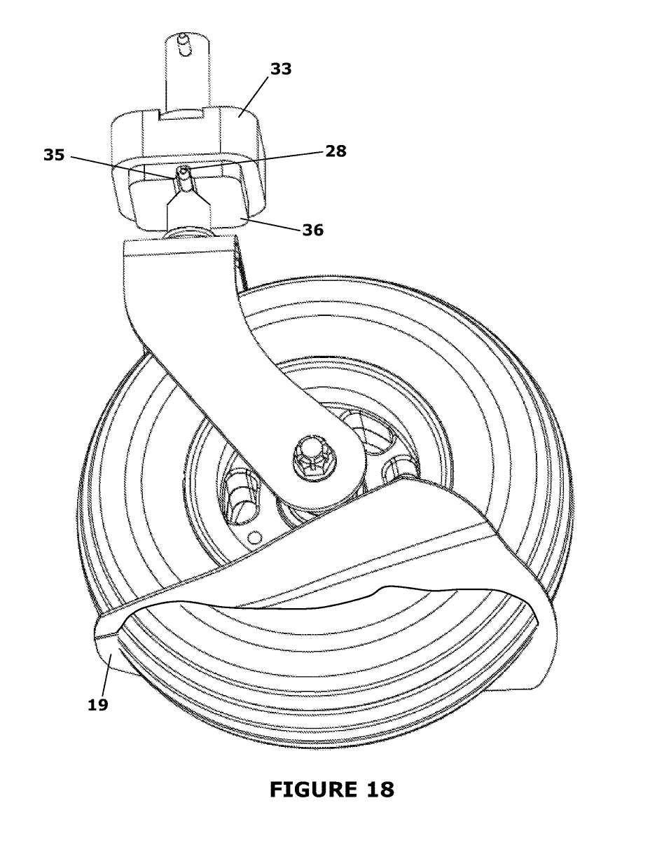

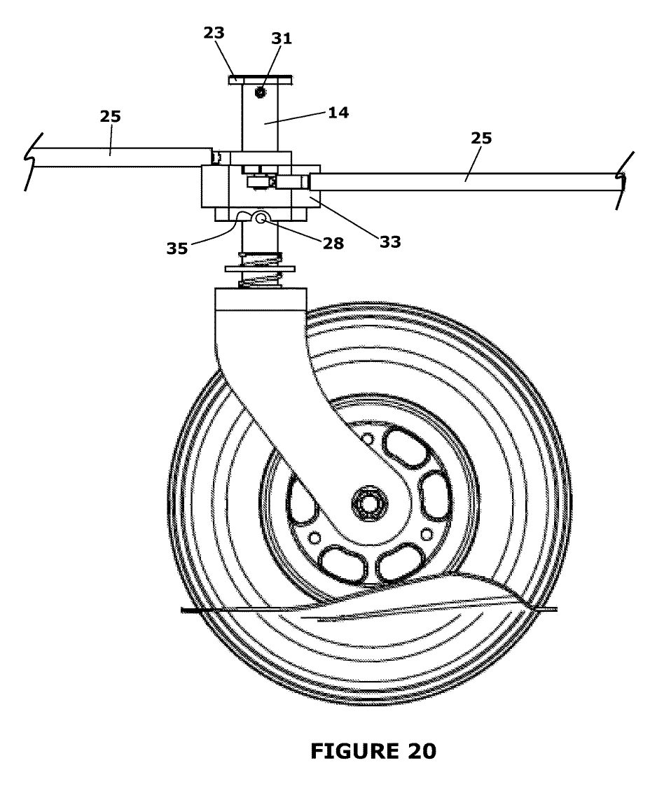

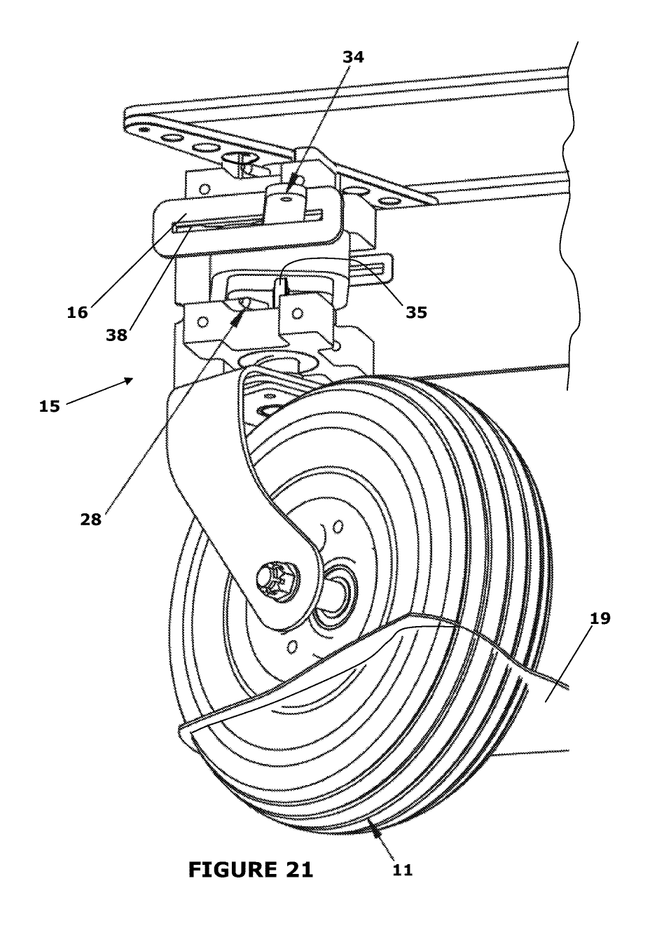

As a result of the axial displacement of the caster axle between an up condition as seen in FIGS. 15 and 16 and a down condition as seen in FIG. 16a, the steering pin 28 is able to move between a condition where it is coupled or keyed to the steering block 33 as shown in FIGS. 18 and 20 and a released condition where it is not coupled or keyed with the steering block as seen in FIG. 21. In the coupled condition, when the wheel is displaced to its up condition, the steering pin 28 is located in a recess 35 of the steering block 33. The steering pin 28 can snugly locate in the recess 35 to thereby key the steering block and the caster axle together. Torque can then be transferred between the steering block and the axle. In the keyed position the steering block when caused to rotate via the steering arm can then turn the wheel. When the wheel is in its down condition and the caster axle 14 is displaced further downwardly relative to the caster axle bearing members 26a and 26b and the steering block, the steering pin 28 is released from the recess 35 and the caster axle is able to rotate independent relative to the steering block 33. The steering block 33 may include a downward facing surface 36 against which the steering pin 28 can bear and slide over until the steering pin is rotationally aligned to the recess and the wheel is sufficiently load bearing. The pin can bear against and slide over the facing surface 36 until the steering pin becomes aligned with the recess 35 to then couple at the recess for rotation to and with the steering block. Alternative ways of releasably coupling the steering block to the caster assembly are envisaged. Such may include axially rather than radially extending steering pins that can push into axially extending apertures of the steering block.

The caster assembly mount 15 preferably also includes caster angle limiting stops 37. These caster angle limiting stops 37 cooperate with the caster limiting pin 21. Preferably the caster limiting stops are provided as part of the upper caster axle bearing member 26b and are positioned so that they will make contact with the caster limiting pin 31 when the relative rotational angle about the caster axis YY reached a predetermined limit. This may for example be 30 degrees each side of the longitudinal axis of the aircraft.

The caster limiting stops 37 may include rubber blocks so that shock absorption capacity is provided for when the wheels reach the limit of rotation. Limiting the caster angle will help to ensure that the rotational position of the wheel(s) is such that it does require a substantial amount of rotation upon touchdown to align with the aircraft track direction. The height (in the direction of the axis y-y) of the caster angle limiting stops 37 may be such that when the wheel is in the up condition, the caster limiting pin 31 is positioned proud of the caster angle limiting stops. This means that the caster limiting pin is no longer in a position able to engage the stops. This means that when the wheel is in the up condition the wheel is not being limited for rotation by the caster angle limiting stops. Although it could be still limited by that or other limiting stops. However when the wheel is in the down condition the caster limiting pin 31 is able to engage with the caster angle limiting stops.

In FIG. 21, the wheel is shown in a down condition and the steering pin 28 is not located in a recess 35 of the steering block 33. In this condition the wheel is able to caster without any steering input control being exerted over the wheel. In FIG. 22 the wheel is in its up condition, more raised than its down condition, and it can be seen that the steering pin 28 is within the recess 35 of the steering block 33. The selective keying/coupling allows for the wheel to both caster independent of steering input and be controlled for steering input via the steering block in different conditions of the aircraft, that will hereinafter be explained.

The steering arm may pass through an aperture 38 in the beam 16. The aperture may provide limits of rotation of the arms. The or each end of the steering arm 34 may, by way of a ball and socked connection or other, be connected to a respective steering connection rod.

In one form where there are a plurality of wheels that are able to caster as part of the landing gear of the aircraft, only one of the wheels need to be provisioned for the purposes of steering. It is preferably the front most wheel. Once the aircraft has touched down on land that one wheel can become controlled for steering by the pilot to thereby cause the aircraft to taxi in a controlled manner. However in the preferred form at least two and preferably all of the wheels of the landing gear of the aircraft are able to be controlled for steering. Each of the wheels is preferably hence provisioned with a castering mount as has been described with reference to FIGS. 15-22.

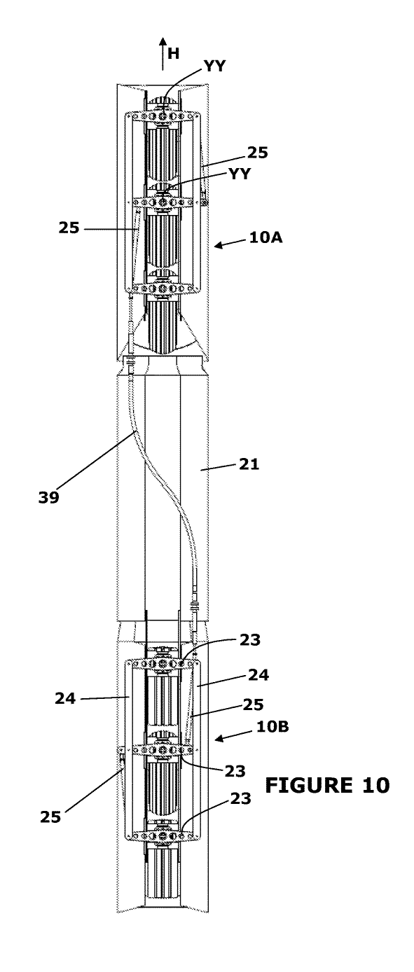

Preferably each of the wheels has its steering mechanism coupled by way of steering connection rods that are provided extending between adjacent steering arms of adjacent wheels. The arrangement of steering arms and steering connection rods of adjacent wheels is such that a plurality of wheels will rotate in the same direction as the others.

Where the aircraft includes a front and a rear landing gear truck. A coupling between the sets of wheels of the front landing gear truck and the rear landing gear truck may be such that the rotation of the wheels of the front landing gear truck is opposed to the rotation of the gears of the rear landing wheel truck. This may be achieved by virtue of a steering cable 39 such as is also known as a Morse cable, being appropriately connected to a steering arm of one of the wheels of the front landing gear truck 10a to a steering arm of a wheel of the rear landing gear truck 10b as shown in FIG. 10. Other connections are also envisaged.

The steering cable 39 is preferably able to transfer force between the steering arms and cause opposed rotation of the wheels of the front and rear landing gear trucks.

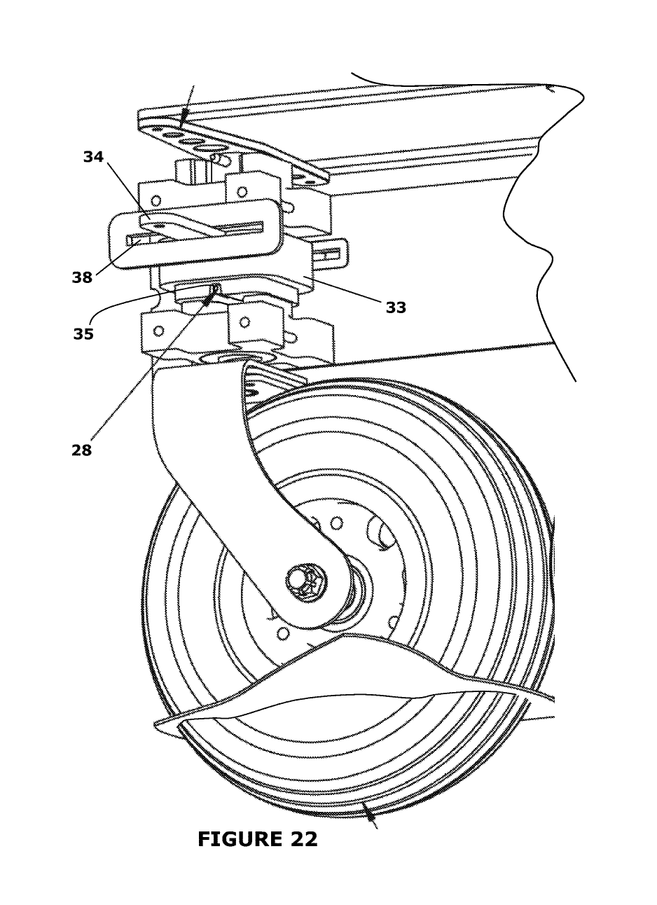

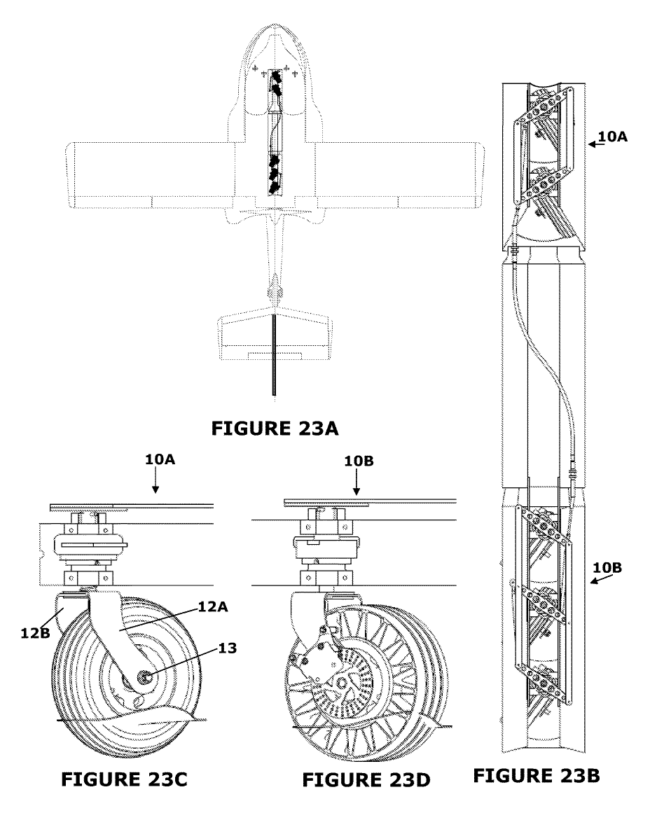

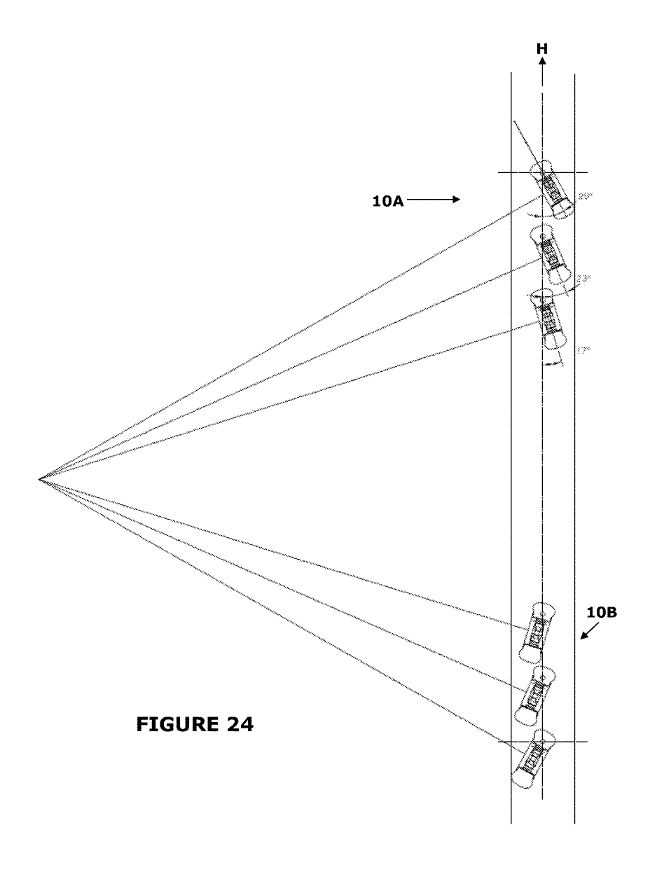

Such opposed motion, whilst optional, is desirable for when the aircraft is taxing. The opposed motion can improve steering of the aircraft when there are a plurality of wheels provided as it allows for the aircraft to more easily turn left and right. This is for example seen with reference to FIGS. 23a-d. In FIG. 23a the aircraft is shown with the landing gear wheels rotated so as to cause the aircraft to turn right when travelling forward. The wheels in FIGS. 23b-d are configured so that the aircraft will turn left when travelling forward.

Where there are a plurality of wheels of a landing gear truck the steering mechanism is such that each of the wheels preferably turns at a different rate to the other wheels in truck. This is shown in FIG. 24 wherein differential steering is illustrated. Preferably in the front landing gear truck 10a the forward most wheel turns at a higher rate than the rear more wheel of that truck. In the rear landing gear truck the rearmost wheel turns at a rate greater than that of the forward more wheel or wheels of the rear landing gear truck 10b. When in a turned condition, all of the wheels preferably have their axes of rotations converging to the same point, when seen in plan view. This differential steering allows for smooth turning of the aircraft when taxiing.

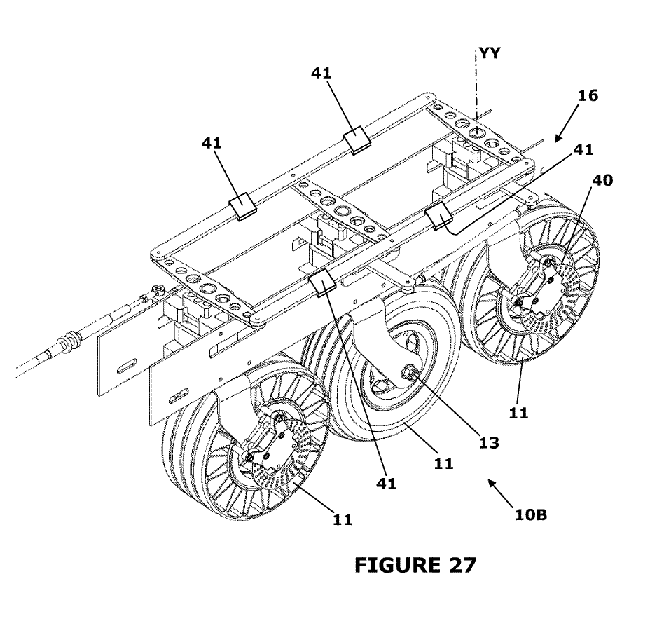

To achieve such differential steering the connection between the steering arms and the steering connection rods of each wheel is different. With reference to rear landing gear truck 10b of FIG. 10, the steering connection rod 25 is engaged at a radially greater distance to the steering arm of the front most wheel of the truck than the steering arm of the intermediate wheel of the rear truck. The steering connection rod 25 coupling the steering arm of the intermediate wheel with the steering arm of the rear most wheel has the steering arm coupled readily outwardly more to the steering arm of the intermediate wheel compared to the radial position connecting the rod 25 to the steering arm of the rear wheel. This geometry helps effect the preferred differential steering capability of the wheels of the rear and front landing gear trucks 10a and 10b.

Where the aircrafts landing gear includes the anti wobble parallelogram mechanism the parallelogram mechanism may require for the link bars 24 to be able to expand and contract in length in order to be compatible with the differential steering mechanics. Otherwise the preferred non-parallelogram configuration of the steering arms and steering connection rods to effect differential steering will fight the anti-wobble parallelogram mechanism. As such the link bars 24 may include an expansion and contraction joint such as a rubber coupling 41 seen in FIG. 27. Other means are also envisaged.

When airborne the wheels are biased to their down condition. By virtue of gravity and/or the spring 30 each wheel is so biased and are each in the condition are able to caster freely. Such castering preferably being in unison by way of the preferred parallelogram mechanism and limited by rotational stops such a rotational stops 37. The compliant membrane at each of the wheels may also bias the rotational position of the wheels towards one position.

Upon landing the weight of the aircraft starts to bear on the wheels. This biases the wheels towards their up condition. Where the recess 35 of a steering wheel block is aligned with the steering pin the wheel is able to move to its up condition with the steering pin within the recess and allowing steering control over the wheel or wheels to be exercised by the pilot. However where the recess and the steering pin are not aligned the wheels are able to remain independent of the steering mechanism.

Where an aircraft is landing in a cross wind direction such as shown in FIGS. 19a and 19b (showing a front wheel of the aircraft prior to the wheel contacting the ground) the rudder position, and hence the steering block position is such that the steering pin is not aligned to the steering block recess. The pilot foot pedals 45, that can provide the pilot controlled steering input of the wheels, are set to turn the aircraft left. The left foot pedal is more forward the right foot pedal. Upon contact with the ground the wheel with become aligned with the aircraft track. Where the steering block rotational positioning and rudder position are coupled, rotational position of the steering block 33 is such that the steering pin is not aligned with a recess 35 of the steering block and therefore the steering control over the wheels still cannot be exercised by the pilot. This is shown in FIGS. 19C and 19D. The wheels will caster, by virtue of contact with the ground to position to align themselves with the track of the aircraft. The steering pin will press against the downward facing surface 36 of the steering block. It is not until the steering block and the steering pin are appropriately aligned in a relative rotational manner that the steering pin can engage with the recess for steering control to then be exercised over the wheel or wheels as seen in FIGS. 19E and F.

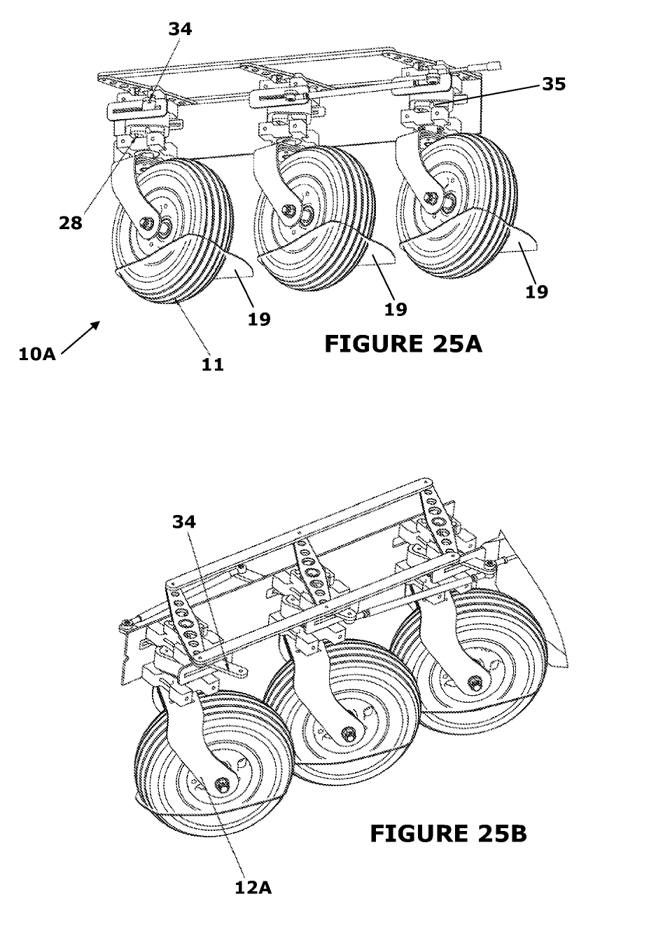

With reference to FIGS. 25a and 25b, the wheels of a front landing gear truck 10b are shown in a position having castered right, this position equating to an aircraft heading being at an angle of say 30 degrees to the runway which may for example be seen in FIGS. 11a and 11b. All the wheels of the rear landing gear truck have castered right so that the axes of rotation of each of the wheels is perpendicular to the track of the aircraft and preferably perpendicular to the direction of the runway. In this condition of the aircraft the rudder/steering is set fully left.

With reference to FIG. 25a it can be seen that the steering arms of each of the wheels of the front truck are positioned in a condition where they are rotated hard left which is preferably also the position corresponding to that of the rudder of the aircraft. The steering pin cannot engage with the recess of the steering block and the wheels are free to caster. This is also shown in FIG. 25b.

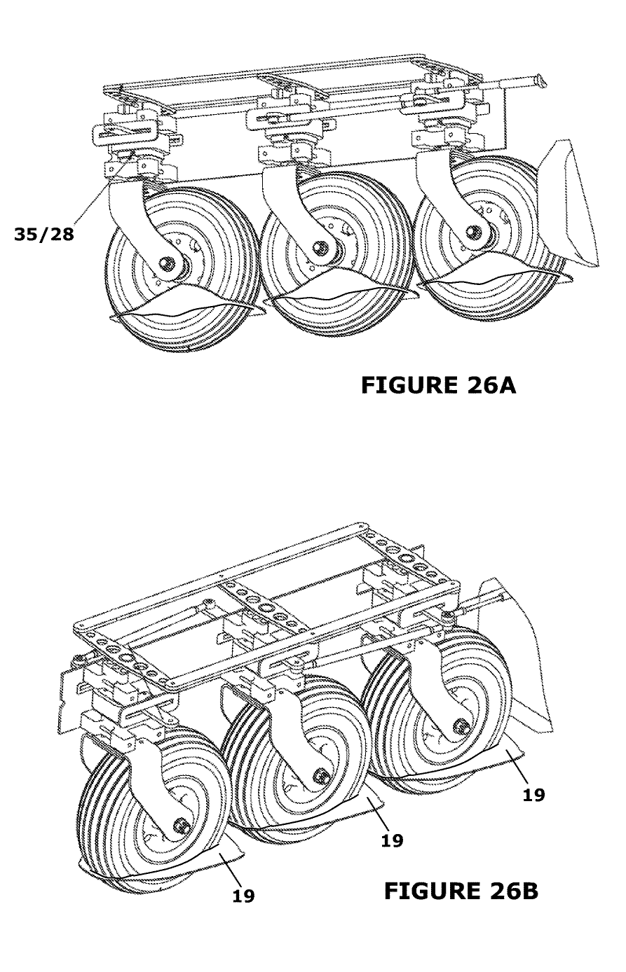

With reference to FIGS. 26a and 26b a rotational position of the wheels of the front truck is shown allowing for the steering pin of each to engage with the recess of the steering block. In this condition the wheels are up, the steering pin is engaged with a recess and steering control can be exercised over the wheels by the pilot.

FIG. 27 is a perspective view of parts of a rear landing gear truck 10b (a mixture of wheel types being shown for illustrative purposes only) where a disc brake arrangement 40 is shown. This allows for the aircraft to be braked such as upon landing. In the preferred form at least a wheel of the rear landing gear truck is braked. Preferably it is the rear most wheel that is able to be braked. Other forms may include front landing gear truck wheel braking. By applying a braking force to a wheel of the rear landing gear truck, the aircraft, if it is landing in a crab position, will by virtue of such braking slowly straighten up and de-crab. This means that whilst the wheels are in the castering condition and no pilot steering control is exercised over any/all of the wheels, the aircraft can still be straightened once touched down, when it is coming in at a crab angle. Progressive braking from the rear towards the front may be a suitable approach to the braking of the aircraft. Or alternatively it is merely a wheel and preferably the rear most wheel of the rear landing gear truck that is braked for the purposes of slowing the aircraft.

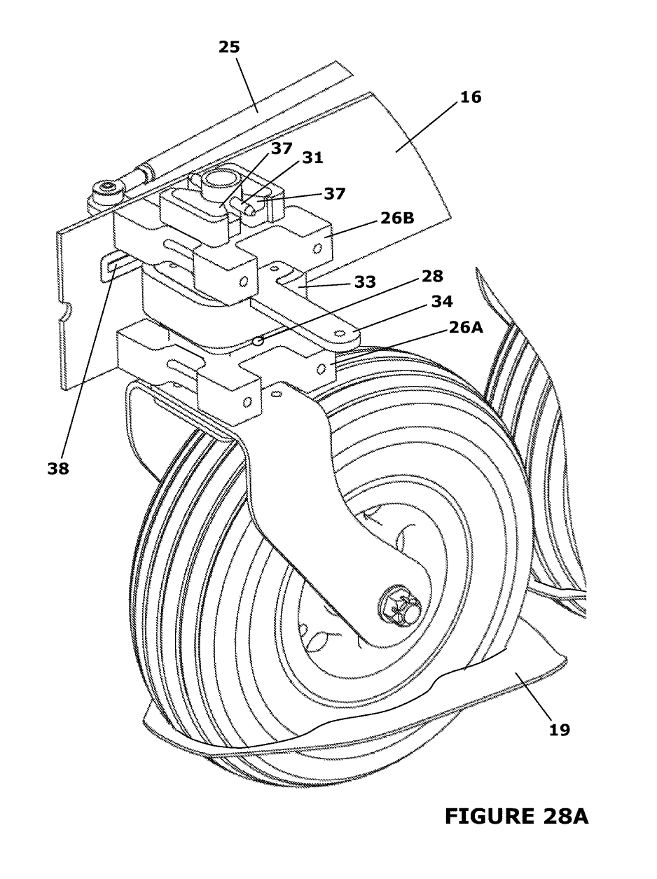

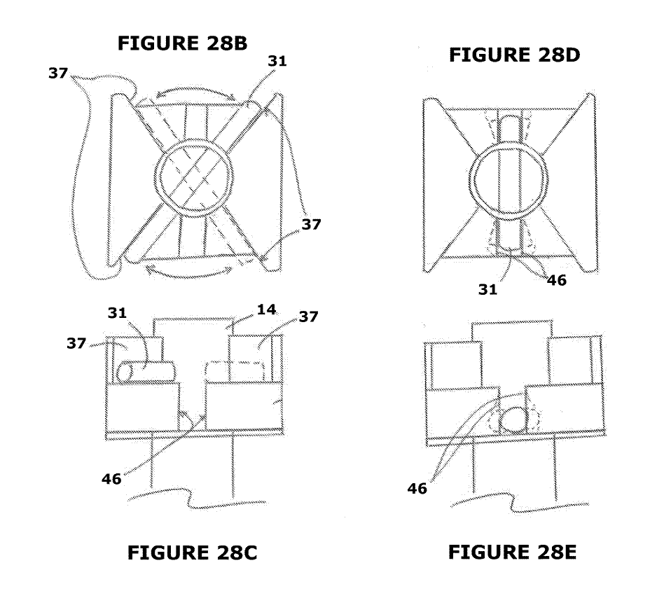

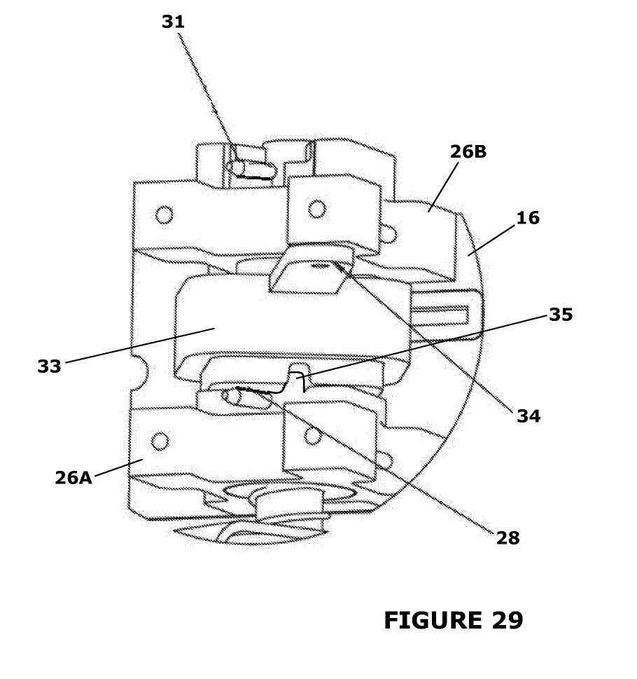

An alternative way of causing the aircraft wheels to straighten up the aircraft upon landing and preferably before steering control is able to be exercised over any/all of the wheels is described with reference to FIGS. 28 and 29. In FIGS. 28 and 29 the caster limiting stops 37 are configured differently compared to that as shown in FIG. 13. The stop surfaces 37 are still provided as per that shown in FIG. 13 however the caster limiting pin 31 is also able to interact with and be biased by more compactly positioned compressible stops 46. The caster limiting pin is, when the wheel is in a down condition, located in between compressible stops 46 that can be compressed but bias the caster limiting pin towards a rotational position that corresponds to the wheel being aligned to the centreline of the aircraft. When the wheel touches down onto the ground, the wheel can be caused to caster if the heading and track are not aligned and the caster limiting pin will then compress a compressible stop. However the compressible stop will bias the pin back to a position where the wheel is aligned to the centreline of the aircraft. This biasing will cause the aircraft heading to move towards its track, thereby straightening up the aircraft. This is so done, without any pilot input.

Once the steering pin and recess are engaged and the wheels are in up condition the caster limiting pin 31 moves vertically and sit above compressible stops and therefore not be biased by them towards the centreline position. This means that a pilot taking steering control over the wheels is not having to fight the force that such compressible stops may otherwise apply to the wheels to bias them towards a centreline position. However when the wheels are in their castering condition and not in their steering condition then the rubber pads will apply a force to bias the wheels to a centreline condition. A sloping surface transition may exist between the rotation limiting stops and the compression stops so that when the aircraft has taken off, the wheels can axially drop to their down condition with the caster limiting pin resetting itself for interaction with the compressible stops.

Caster rotation limiting stops 37 are optional. So are the compressible stops.

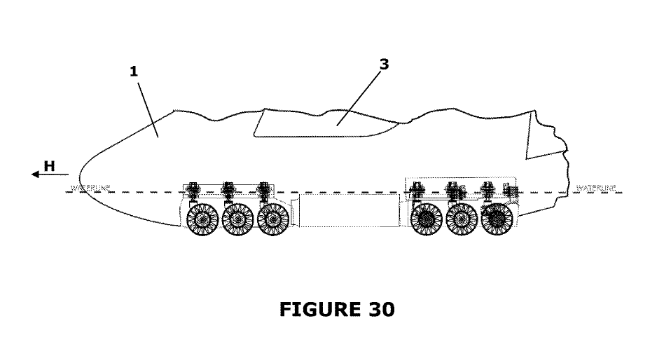

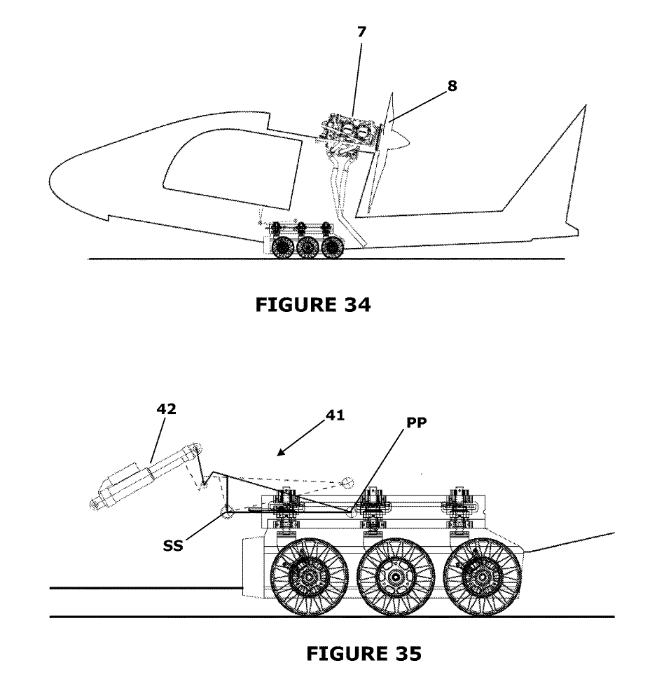

With reference to FIGS. 30-35 the landing gear truck arrangement as part of an aircraft is illustrated wherein the front and back landing gear trucks are able to independently move relative to the aircraft fuselage. In the preferred form the front landing gear truck 10a is substantially independently mounted to the fuselage to the rear landing gear truck 10b. A bridge member 21 may be provided intermediate of the front and rear landing gear trucks as seen in FIGS. 30-33. The bridge may be provided for the purposes of keeping a relatively smooth surface between the independently movable front and rear landing gear trucks which can facilitate the planing of the hull when in water. The bridging member 21 is optional. Preferably each of the front and rear landing gear trucks are able to both translate and rotate relative to the aircraft fuselage. A suspension arm mechanism 41 as shown in FIG. 35 may be provided. The suspension arm mechanism may be mounted about a suspension pivot axis SS. The landing gear truck may be mounted in a pivotal manner at the pivot PP to the suspension arm mechanism 41. Preferably the axes PP and SS are parallel to each other and perpendicular to the centreline of the aircraft. This allows for the landing gear truck to move on an arc about the axis SS but to not be rotated. This allows for the truck to articulate around axis PP where for example upon landing the truck can pivot about axis PP in order for all of the wheels of the truck to promptly make contact with the ground. A spring and/or damper and/or hydraulic cylinder 42 may form part of the suspension arm mechanism.

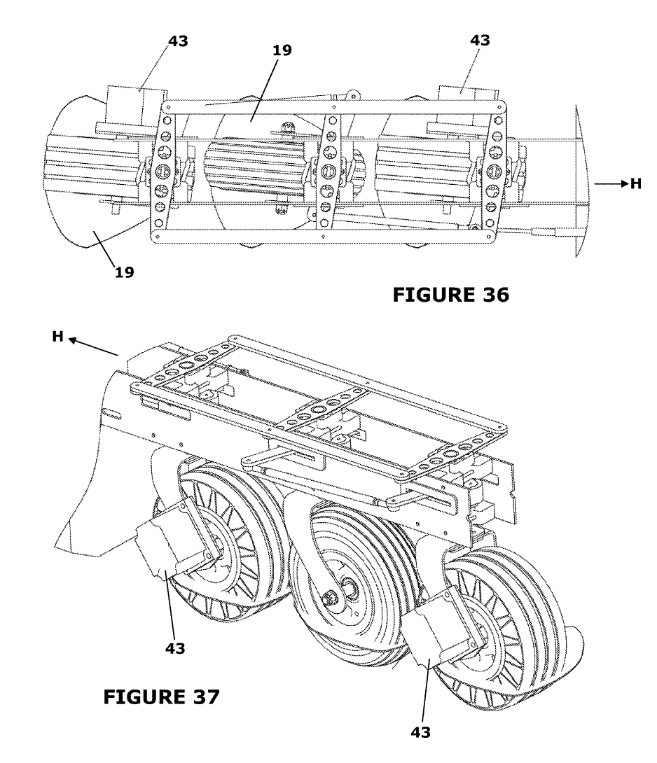

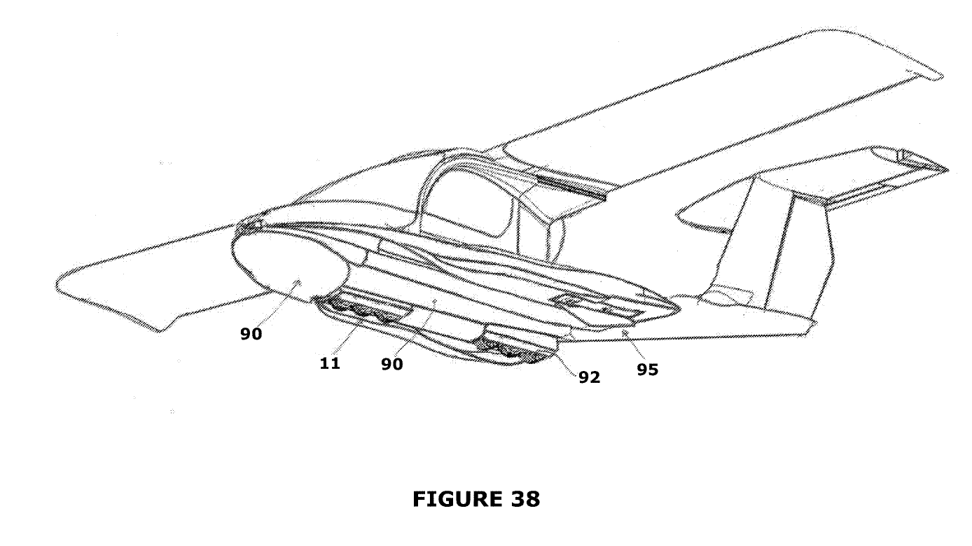

FIGS. 36 and 37 show part of a landing gear truck wherein at least some of the wheels of a truck are engaged to hydraulic motors 43. Hydraulic motors can power the wheels to drive the aircraft along the ground. In addition such hydraulic motors may be configured for the purposes of braking the aircraft. So whilst the caster wheels are able to turn and caster idle, they are also able to be powered to turning to cause the plane to move over ground.

The description so far primarily refers to an aircraft and its landing gear. In the preferred form the aircraft is an amphibious aircraft that is able to land both on land and water. Wheels are described as the mode for moving on land. The wheels can roll over land. Wheeled tracks, such as those found on snow-mobiles are also envisaged as an alternative to wheels to allow rolling contact with the ground.

The aircraft fuselage preferably includes a hull form at the bottom at where the wheels are presented, that is adapted for the purposes of landing on water. Preferably the hull form is both hydrodynamically and aerodynamically formed for travel in water and in air.

The hull includes a recess providing a housing for the wheels to be located. The housing is configured to help facilitate with the hydrodynamics of the hull form of the amphibious version of the aircraft as a result of the housing presenting itself in a manner to (a) reduce the ingress of water into the housing (b) reduce contact between water and the wheels whilst the aircraft is moving on water and (c) provide some of the surface of the aircraft that provides the hydroplaning surface for the aircraft.

Preferably only a small portion of the wheels total height is exposed out of a lower surface 90 of the hull. Shrouding may be provided about the wheels to help prevent water from entering the housing, particularly when landing in water. As described previously the compliant membrane 19 helps achieve this. The compliant membrane 19 may be formed of a neoprene or rubber or other suitable stretchable material that allows the wheels to turn yet still encapsulate the wheel to prevent water ingress. Alternatively a system of nested plates may be provided on lateral sides of the wheels that are able to extend and retract and slide over each other as the wheels turn yet prevent or reduce ingress of water into the housing(s) when travelling through water.

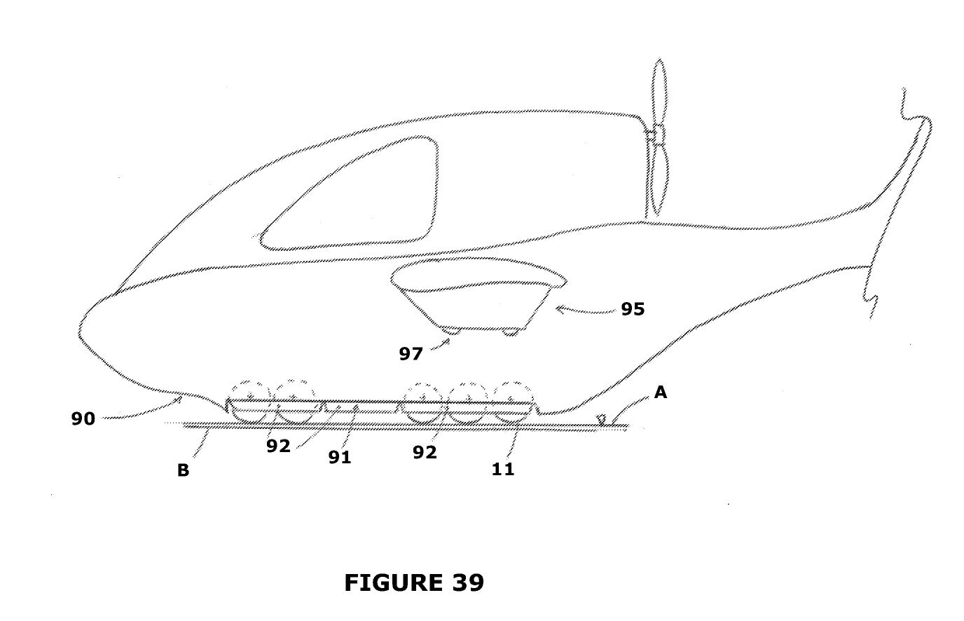

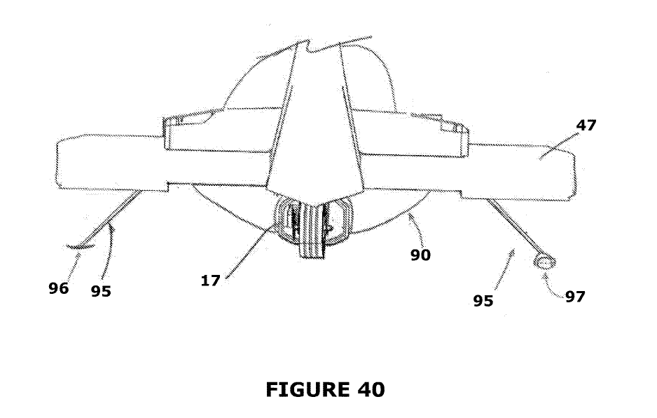

An important safety aspect of this aircraft is that the landing wheels are always positioned for landing on land and in such position is also capable of safely landing on water. The pilot does not need to activate the landing gear between retracted and extended conditions. Preferably each wheel of each truck is housed in a dedicated recesses of the hull form, preferably provided in the lower surface 90 of the hull. The wheels are presented outside the hull in a manner to minimise exposure of the wheels extending below the lower surface yet exposing them sufficiently to allow the aircraft to land on land without the hull form scraping the ground. The wheels preferably remain exposed all the time for landing on land. There is preferably no need for a pilot to deploy or expose the landing wheels for landing on land. FIG. 39 shows the wheels in contact with the ground A and the weight of the aircraft bears upon them. A notional line B in FIG. 39 shows a possible position of the bottom of the wheels with respect to the fuselage when they are in flight and do not have the weight of the aircraft bearing upon them. The wheels, as shown by lines A and B when in the up and in the down condition respectively, are not exposed any great distance out of the hull. Due to the wheels having such minimal exposure there is no need for retraction of the wheels before landing in water as the wheels provide little interference when landing on water. Having minimal exposure of the wheels from the lower surface of the hull reduces any chance of the aircraft landing and “flipping” about its wheels into a nose dive.

Sponsons 47 may be provided to help offer stability to the aircraft when in water. Sponsons can help provide stability and prevent the aircraft from excessive rolling when in water, especially when sitting idle in water. The sponsons are adapted and configured to help keep the aircraft's wings out of the water.

The aircraft is preferably also equipped with supporting elements 95. These may depend from the wings or from the sponsons. The supporting elements may be arms at the distal ends of which wheels 97 for landing on land and/or hydrodynamic fins or foils for when landing on water may be provided. The foils are preferably adapted and configured to, when travelling through/on water, hydroplane. When at rest the supporting elements may be sufficiently buoyant to help prevent excessive roll of the aircraft in water.

The wheel 97 of each supporting element may act in a similar fashion when landing on land by keeping the wing tips from touching the ground. The wheels 97 may be castered or fixed. Furthermore there may be multiple wheels 97 in line or there are multiple wheels side-by-side, or both.

In a preferred embodiment the supporting elements present both hydroplaning fins and caster wheels. The support elements may comprise a water-ski like member 96 which allows the support elements to plane on the water when landing.

The supporting elements may include suspension which allows the supporting elements to take some shock impact when loading. In a more preferred embodiment the supporting elements are fixed relative to the fuselage.

1-58. (canceled)

59. An aircraft comprising
a. a fuselage (2)
b. an undercarriage dependent from the fuselage (2), the undercarriage including at least one caster assembly (10a/b) mounting a landing wheel (11) to provide vertical support for the aircraft (1) when on land and able to caster relative the fuselage (2).

60. An aircraft as claimed in claim 59, wherein the fuselage (2) is an elongate fuselage (2) extending along the aircraft's longitudinal axis (H), the caster assembly (10a/b) comprises a caster axle (14) mounted for rotation on a caster axis (YY) that is parallel a vertical plane that passes through the longitudinal axis (H).

61. An aircraft as claimed in claim 60, wherein the caster axis (YY) lies in the vertical plane.

62. An aircraft as claimed in claim 59, wherein at least two caster assemblies are provided each mounting a respective landing wheel (11) to provide a landing wheel (11) more proximate the nose of the aircraft and a landing wheel (11) more proximate the tail of the aircraft.

63. An aircraft as claimed in claim 62, wherein each caster axis (YY) of each caster axle (14) are parallel each other.

64. An aircraft as claimed in claim 59, wherein the landing wheel (11) is mounted for rotation by said caster assembly (10a/b) about a wheel axis (X).

65. An aircraft as claimed in claim 64, wherein when the wheel axis (X) is perpendicular the aircraft's longitudinal axis (H) when seen in plan view, the aircraft (1) when moving forward on land, will travel in a direction (track) coincident the aircraft's longitudinal axis (H).

66. An aircraft as claimed in claim 64, wherein when the wheel axis (X) is not perpendicular the aircraft's longitudinal axis (H) when seen in plan view, the aircraft (1) when moving forward on land, will travel in a direction (track) at an angle to the aircraft's longitudinal axis (H).

67. An aircraft as claimed claim 59, wherein the caster assembly (10a/b) can, in a first condition, allow the landing wheel (11) to freely caster and in a second condition, causes the caster axle (14) to be coupled to pilot controlled steering input that can control the operative rolling direction of the landing wheel (11) when the aircraft (1) is travelling on land.

68. An aircraft as claimed in claim 59, wherein the caster assembly (10a/b) in a first condition allows the landing wheel (11) to freely caster and in a second condition is coupled to a steering mechanism of said undercarriage.

69. An aircraft as claimed in claim 59, wherein the steering mechanism is operatively connected to pilot operable steering input (eg foot pedals) that (a) when the caster assembly (10a/b) is in its first condition, is decoupled from the caster axle (14) and (b) when moving from the first condition to the second condition of the caster assembly (10a/b), by an upward movement of the caster axle (14) relative the fuselage (2), can cause the steering mechanism to couple with the caster axle (14).

70. An aircraft as claimed in claim 68, wherein the steering mechanism includes a steering block engaged to a steering arm that is operatively connected to pilot operable steering input (eg foot pedals), the steering block and caster axle (14) mounted for relative movement to each other to (a) allow relative rotation about the caster axis (YY) when the caster assembly (10a/b) is in its first condition and (b) allow relative displacement in the caster axis direction when the caster assembly (10a/b) moves between its first and second conditions.

71. An aircraft as claimed in of claim 69, wherein the aircraft's rudder (6) and steering mechanism are coupled so that when the aircraft is landing in a crabbed condition and the rudder (6) is position to maintain the aircraft (1) on track, the steering mechanism cannot couple to the caster axle (14) when the landing wheel's rotational axis (XX) is perpendicular to the track of the aircraft (1).

72. An amphibious aircraft comprising a primary fuselage (2) presenting a hull form extending along the aircraft (1) centreline to support the amphibious aircraft (1) on water, and at least one landing wheel (11) mounted at and partially yet sufficiently exposed from a recess (35) in the hull form to be able to support the amphibious aircraft (1), including for landing and take-off, on land.

73. An amphibious aircraft as claimed in claim 72, wherein the at least one landing wheel (11) has its rotational axis (X) positioned inside the recess (35) and less than half the wheel (11) is exposed from the recess (35) outside the hull form.

74. An amphibious aircraft as claimed in claim 72, wherein the at least one landing wheel (11) is positioned at the centreline of the amphibious aircraft.

75. An amphibious aircraft as claimed in claim 72, wherein the at least one landing wheel is always presented in a manner capable of landing and support of the amphibious aircraft (1) on land.

76. Landing gear of or for an aircraft comprising:
at least two trucks (10a/b) placed in-line with the longitudinal direction (H) of the fuselage (2) of said aircraft (1) each truck (10a/b) provided with at least one wheel (11) presentable relative to the fuselage (2) to make rolling contact with ground to at least partly support the weight of the aircraft (1),
a steering input engagement mechanism to selectively couple with at least one wheel (11) to assist with the directional control of said aircraft (1) whilst moving over the ground,
wherein at least the forward most wheel is mounted to be able to caster about a caster axis (14), when in rolling contact with the ground.

77. Landing gear as claimed claim 76, wherein at least the forward most wheel is able to caster about a caster axis (YY) substantially perpendicular to said longitudinal axis of said aircraft.

78. Landing gear as claimed in claim 76, wherein the engagement mechanism is able to couple with said wheel(s) to control rotation of the wheel(s) about the caster axis (YY) only when the aircraft rudder (6) is in a position that would cause the aircraft (1) to travel in the same direction in the air as the wheels would when in rolling contact with the ground.
